(19) United States
(12) Patent Application Publication
(10) Pub. No.: US 2017/0329910 A1
(43) Pub. Date: Nov. 16, 2017

(54) Healthcare Payment Network

(71) Applicant: Ragui Selwanes, Austin, TX (US)

(72) Inventor: Ragui Selwanes, Austin, TX (US)

(21) Appl. No.: 15/588,014

(22) Filed: May 5, 2017

Related U.S. Application Data
(60) Provisional application No. 62/336,866, filed on May 16, 2016.

(51) Int. Cl. G06F 19/00; G06Q 20/40; G06Q 20/10; G06Q 50/24; G06Q 30/06

(52) U.S. Cl. CPC G06F 19/328; G06Q 50/24; G06Q 30/06; G06F 19/322; G06Q 20/102; G06Q 20/40

(57) ABSTRACT

A system is disclosed which allows gives the Provider the ability to safely and securely transfer funds via a counterparty enabled “pull” from the Payer's account to the Provider's account for payments made by ACH or VCN. The system is based upon a token embedded in the remittance to claim (pull) the funds and sent to the provider and a trusted party used for transferring funds from the payer's account to the provider's account. The provider is thus able to “pull” funds from the provider by using the token embedded in the remittance advice. The token is provided to a trusted party who transfers the funds relating to the token. The use of the token and the change of process flow requiring the provider to pull the funds instead of having the funds pushed into their account eliminates any mismatch between the claim and the payment for the claim.

### BACKGROUND OF THE INVENTION

### 1. Field of the Invention

The present system is an improvement to a healthcare payment network for facilitating reconciliation of a remittance with an originating claim.

### 2. Description of the Prior Art

Healthcare spending is one of the largest expenditures within the US economy, trending at roughly three trillion dollars ($3T) annually. Of the $3T spent, more than two thirds of the volume move between 3^{rd} party payers (e.g. government agencies such as Medicare and Medicaid; insurance companies; and third party administrators—“Payers”) and medical service providers (e.g. hospitals, physicians, dentists, home healthcare providers, pharmacies, research organizations, testing facilities, and durable medical equipment providers, to name a few—“Providers”).

Despite the enormous volume and aggregate dollar value, a large volume of individual payments are made via paper checks and paper remittances (EOP=Explanation of Payment), with a small subset of EOP's also being paid by Credit Card known as VCN's (Virtual Card Numbers). The remainder of transactions are made via Automated Clearing House (ACH) processes. In the case of check payments, costs to print, mail, receive, deposit and reconcile each payment are significant. In addition to these expenses, VCN's add the incremental costs associated with acquiring credit card transactions which can range between 3%-5% incrementally.

In the case of ACH payments, the volume of these payments are constrained by the inability to connect individual ACH payments to the details supporting the payment unless the Payer's system is tied into the hospital's system or the hospital's system is tightly integrated with their banking system. The difficulty and expense of connecting many uniquely configured and different Payer systems to many uniquely configured and different Provider systems limits the automation of the ACH process to the largest Payers and Providers (e.g. major insurance carriers tied to major hospital chains). Without these connections, the Providers must expend material resources to reconcile payments to the details of the charges. These details are provided either in paper form via an Explanation of Payment (“EOP”) or electronically through data exchanges or by point to point connections, via what is known as a HIPAA (Health Insurance Portability and Accountability Act) 835 transaction (a mandated and standardized electronic form of the EOP). The HIPAA 835 transaction is the healthcare industry's standardized Electronic Data Interchange (EDI) remittance, which provides claim payment information for healthcare practices, facilities and billing companies to auto post claim payments into their systems.

Today, Payers and Providers expend approximately forty-two billion dollars ($42B) of processing costs. Table 1 below breaks down healthcare payment processing costs by Payer channel and payment type.

TABLE 1
Healthcare 3^{rd} Party Payments¹

| Type of | | | | | | | | | | |
|---|---|---|---|---|---|---|---|---|---|---|
| Expenditure | Projected | | | | | | | | | |
| (billions $) | 2015 | 2016 | 2017 | 2018 | 2019 | 2020 | 2021 | 2022 | 2023 | 2024 |
| Private Health | 896 | 940 | 987 | 1,040 | 1,099 | 1,163 | 1,231 | 1,300 | 1,372 | 1,447 |
| Insurance | | | | | | | | | | |
| Medicare | 538 | 570 | 605 | 643 | 694 | 750 | 809 | 872 | 939 | 1,009 |
| Medicaid | 339 | 353 | 372 | 393 | 417 | 442 | 468 | 497 | 528 | 560 |
| Other Health | 98 | 104 | 110 | 116 | 123 | 131 | 139 | 147 | 156 | 165 |
| Insurance | | | | | | | | | | |
| Programs | | | | | | | | | | |
| Other Third Party | 168 | 178 | 189 | 201 | 212 | 223 | 236 | 248 | 260 | 273 |
| Payers | | | | | | | | | | |
| Total In-Scope | 2,039 | 2,145 | 2,263 | 2,393 | 2,545 | 2,709 | 2,882 | 3,064 | 3,255 | 3,454 |
| Spend | | | | | | | | | | |
| # Electronic | 201 | 222 | 246 | 273 | 303 | 336 | 372 | 411 | 454 | 499 |
| Transactions | | | | | | | | | | |
| (mm) | | | | | | | | | | |
| # of Paper | 4,278 | 4,209 | 4,152 | 4,089 | 4,032 | 3,956 | 3,854 | 3,720 | 3,549 | 3,340 |
| Transactions | | | | | | | | | | |
| (mm) | | | | | | | | | | |
| Total # of | 4,479 | 4,431 | 4,398 | 4,361 | 4,335 | 4,293 | 4,226 | 4,131 | 4,002 | 3,839 |
| Transactions | | | | | | | | | | |
| (mm) | | | | | | | | | | |

| | | |
|---|---|---|
| | Cost Per | |
| Processin | Claim | Cost Per Payment |

| Costs | Claims/Pmt | Provider | Payer | Provider | Payer | Total |
|---|---|---|---|---|---|---|
| ACH Processing | 5 | $1.11 | $0.05 | $5.55 | $0.25 | $5.80 |
| Check | 2.2 | $4.15 | $0.18 | $9.13 | $0.40 | $9.53 |
| Processing | | | | | | |

| | 2015 | 2016 | 2017 | 2018 | 2019 | 2020 | 2021 | 2022 | 2023 | 2024 |
|---|---|---|---|---|---|---|---|---|---|---|
| ACH $mm | | | | | | | | | | |
| Provider | $1,116 | $1,234 | $1,366 | $1,513 | $1,681 | $1,865 | $2,066 | $2,284 | $2,518 | $2,769 |
| Processing Costs | | | | | | | | | | |
| Payer Processing | $50 | $56 | $62 | $68 | $76 | $84 | $93 | $103 | $113 | $125 |
| Costs | | | | | | | | | | |
| Total ACH | $1,166 | $1,290 | $1,428 | $1,581 | $1,757 | $1,950 | $2,159 | $2,387 | $2,631 | $2,894 |
| Processing | | | | | | | | | | |
| Costs | | | | | | | | | | |
| Check $mm | | | | | | | | | | |
| Provider | $39,055 | $38,425 | $37,905 | $37,332 | $36,812 | $36,122 | $35,187 | $33,964 | $32,401 | $30,491 |
| Processing Costs | | | | | | | | | | |
| Payer Processing | $1,694 | $1,667 | $1,644 | $1,619 | $1,597 | $1,567 | $1,526 | $1,473 | $1,405 | $1,323 |
| Costs | | | | | | | | | | |
| Total | $41,915 | $41,381 | $40,977 | $40,531 | $40,165 | $39,638 | $38,873 | $37,823 | $36,437 | $34,708 |
| Processing | | | | | | | | | | |
| Costs $mm | | | | | | | | | | |

¹SOURCE: Centers for Medicare & Medicaid Services, Office of the Actuary.
Total US Healthcare Expenditure = $3.2T in 2015
Electronic/Paper source = CAQH 2014 Index, 2014 & 2015 NACHA Published Healthcare ACH Transaction Counts

Despite major initiatives and material expenditures to execute Provider to Payer integrations and enable more ACH payments, the difficulties described above limit ACH to 8% of transactions and 64% of the dollars paid². ² Ratio of payments falling when converted to ACH: There is better consolidation with 835's and ACH's vs. check. The average number of claims with ACH are 5 vs. 2 with check. This is largely because hospital claims are the majority of ones going electronic that carry multiple line items

This is in an age of material progress in automation and digitization in almost all other industries. Consumer Point of Sale (POS) retail transactions shifted from 100% cash and check to 67% credit card from 2003 to 2012³. The fact that there is no widely accepted or consistent forecast of the timing and velocity of migration from paper to electronic in healthcare payments is an indication of how innovative a concept is that would potentially shift 100% of payments from paper to electronic. ³ The 2013 Federal Reserve Payments Study

The Complexity Associated with the US Healthcare System—Billing, Adjudicating Claims, and Reconciling:

The primary drivers of payment costs in healthcare are manual posting, reconciling, payment generation and payment clearing. FIG. 1 is a flowchart of a known process for providing the healthcare service through receipt and reconciliation of payment. The details of each step-in FIG. 1 are as follows:
a) The process starts with the delivery of healthcare services by medical Providers to patients associated with various check-ups and ailments, from in office care to lab work to emergency services to hospitalization and post-ailment rehabilitation & service.
b) Providers generate a “super bill” at the time care is rendered, containing proprietary descriptions of the services and procedures rendered. A super bill is often hand written, by the care provider, and serves as the inventory of care and medications delivered to the patient, and becomes the basis to create the originating claim submission. In healthcare, the claim submission is the equivalent of an invoice in the retail world.
c) Details of the Super Bill are entered into a Provider's patient accounting system, often referred to as either a Practice Management System (PMS) or Hospital Information System (HIS). Entering the information allows a provider to maintain an official record of activities performed on a patient, and PMS′/HIS' are the first systematic point to create a medical claim that will be submitted to healthcare payers.
d) Standardized Claims are generated based on the Super Bills, for the services provided. These claims are comprised of components or line items representing each element of service delivered to the patient, and standardize the Super Bill notes to industry accepted procedure codes.
   i. Standardized claim submissions are generated for healthcare services, items and drugs provided to patients by the provider's computer system and submitted to payers for payment in a known manner, for example, via a remittance advice, commonly known as a EDI HIPAA 837 transaction or a paper based claim form. See FIG. 6B which illustrates an exemplary 837 form. The HIPAA 837 transaction is the healthcare industry's standardized claim submission transaction, and similar to paper based claims forms typically includes a description of the patient, the patient's condition for which treatment was provided, the services provided and the cost of the treatment.
   ii. The claim submissions list a number of standardized codes that represent services, items and drugs provided to patients by a health care provider. These standardized codes are known as the International Classification of Diseases, 10th Revision (ICD 10) and, Current Procedural Terminology (CPT). ICD codes are used for activities related to diagnostics, and CPT codes are used for procedures performed. As such, a single claim can be comprised of one or many line items associated with the care delivered and include charges for a variety of services, items and drugs (e.g. x-rays, EKG's, routine check-ups, the administration of medications, splints, drugs, etc.). Each line item typically has an ICD or CPT code associated with it, which identifies to healthcare Payers what diagnostics and procedures were rendered and are being billed for.
e) Once claims have been created, they are submitted to healthcare payers via mail in the case of paper claims, or via a healthcare clearinghouse in the case of HIPAA 837 electronic claim by way of the provider's computer system. Examples of healthcare clearinghouses include Change Healthcare, Navicure, Gateway EDI, all of whom maintain electronic data networks that connect healthcare payers with healthcare providers for the transmission of Electronic Data Interchange (EDI) transactions. Such EDI transactions are transactions which allow one entity to electronically send information to another entity using a standardized format. Payers process claim submissions using their adjudication systems. An adjudication system may include a computer platform that maintains the full inventory of ICD and CPT codes, and the specifically negotiated rate which is set between each healthcare provider and the provider for each ICD and CPT code.
f) Upon completion of the adjudication process, the Payer creates either an electronic remittance (835) or a paper based remittance (Explanation of Payment: EOP), which explains how a claim was processed. FIG. 6A illustrates an exemplary 835 form. Both the electronic remittance and the paper remittance include discounts applied, i.e. negotiated rates, disallowed procedures, and the patient liability. Accompanying the remittance is a payment instrument, typically in the form of a paper check, automated clearinghouse (ACH) electronic funds transfer, or virtual card number (VCN). With the existence of two types of remittances (electronic or paper), and three primary payment disbursement modalities (Check, ACH, VCN), several permutations exist of how the provider will receive the remittance and payment.
i. Option 1: The payer can generate 835 electronic remittances
   [symbol] The payer transmits the 835 to the healthcare Provider via a healthcare clearinghouse, similar to the way a Provider transmits an 837-claim submission.
   [symbol] The 835 is received by the healthcare Provider's PMS or HIS system, and posted to the patient account. Because the data fields in an 835 remittance are standardized, technology companies that provide the PMS and HIS platforms are able to develop a mapping table, whereby each specific field included in an 835 is mapped to a respective field within their platform's database which correlates to a relevant data element of the patient's account. Furthermore, based on certain data elements that exist in both the 837 and 835 such as patient name, claim control number, patient member number, etc. a Provider's PMS or HIS is able to link the 835 to the originating 837 claim submission but not necessarily the payment information.
   [symbol] Based on the results and adjustments of the Payer's adjudication, as reflected by the posted 835, Provider's proceed with follow-up claim related activities, such as patient balance billing, denials follow-up or claim write-offs. Of note however, is that the 835 simply represents the remittance which explains how and why a Payer is paying for the originally submitted claim. The 835 is not an actual payment vehicle like a check, ACH or VCN which is also be transmitted as part of the process.
ii. Option 1A: In one example of how payment is issued with an 835 remittance, Payers will generate an ACH electronic funds transfer to provide the payment funds associated with the 835.
   [symbol] To generate an ACH, a payer creates an ACH instruction. The ACH instruction typically includes the Provider's name, the Provider's bank information, the Provider's bank account information, and the date on which to send payment
   [symbol] The ACH instruction is transmitted to the Payer's bank for processing
   [symbol] The Payer's bank transmits the ACH from the Payer's account based on the instructions received. With every ACH transaction, an ACH trace number is created, and serves as an identifier for the transaction. Trace numbers are typically unique, can be 15 digits long and contain numeric values. Usually the first 5 digits will identify the originating counterparty (bank identifier where the funds are originating from). In essence, the trace number is a token, which serves to identify or link the funds received to the corresponding 835. In fact, HIPAA requires that the correct trace number associated with the ACH also be included in the 835 TRN segment.
   [symbol] The healthcare Provider's bank receives the ACH electronic funds transfer which in theory corresponds to an 835 remittance which has been received by the Provider.
   [symbol] The essence of the problem with the 835 & ACH process is illustrated in FIG. 1. The Payer generates the 835 out of their system in box (g1i) and the Bank generates the trace number in box (g1aiii), two separate and distinct processes. By the time the trace number is generated by the bank, the 835 has already left the Payer's system and has been transmitted by a healthcare clearinghouse (box g1ii). Thus, the trace number is not included on the 835 before the ACH instruction is sent to the healthcare provider's bank. The funds authorized by the ACH instruction are then typically “pushed” to the healthcare provider's bank and into their account with a trace number that is not correlated with the 835. Considering the volumes of transactions. it becomes extremely difficult, if not impossible, for the healthcare provider to reconcile the funds transfer into their account with an 835. Without significant resources including personnel, capital and time; building capabilities to populate correct trace information within the 835 is all but impossible except for the largest most sophisticated payers (e.g. UHC, AETNA, Cigna, Humana) in the country. Smaller payers including third party administrators (TPA's) have had a very difficult time complying with the HIPAA requirements, and as a result, have had no choice but to default to paper remittance and payment processes.
iii. Option 1B: In another example of how payment is issued with an 835 remittance, Payers will generate a paper Check or VCN to provide the payment funds associated with the 835.
   [symbol] In the case of check, a check is issued and sent to the Provider via US mail system. In the case of VCN, it is printed on a piece of paper, along with corresponding security codes, expiration dates and the authorization amount and is sent to the Provider via US mail systems. The VCN format is based on those prescribed by the Payment network which issues it. For example, Discover, MasterCard and Visa require card numbers to contain 16 numeric digits. American Express requires 15 numeric digits. In all cases, the card number can be thought of as a token, that is uniquely assigned to each payment.
   [symbol] When the healthcare provider receives the check or VCN, they notate that payment has been received, and apply it to the specific patient account within their PMS or HIS. In either case, check or VCN, the mailing includes patient and claim identification information that allows the Provider the correct patient account to apply the payment to. Because the Provider is able to visually match the patient information on the payment to the patient information located in their PMS/HIS, they can correctly post the payment within their system. This is unlike and distinguished from an ACH transaction which typically only provides a trace number as a link back to the 835 remittance.
iv. Option 2: In yet another example of how remittances and payments are transmitted by payers to providers; a Payer may generate a paper based explanation of payment (EOP), with a check payment attached to the bottom of the EOP.
   [symbol] The EOP & Check are mailed to the Provider via the US mail system
   [symbol] The provider receives the EOP & check, manually enters the information found in the EOP into their PMS or HIS to accurately reflect the payer's disposition of the claim against the patient's account
   [symbol] The provider deposits the check in their bank account
   [symbol] Although paper EOP's and checks are expensive to generate and the most manually intensive to post, it represents the Provider's most accurate way to link payment with remittance. This is based on the simple fact that both the check and EOP are received together.
v. Option 3: In yet another example of how remittances and payments are transmitted by payers to providers; a Payer may generate a paper based explanation of payment (EOP), with a VCN payment attached to the bottom of the EOP.
   [symbol] The EOP & VCN are mailed to the Provider via US mail system
   [symbol] The provider receives the EOP & VCN, manually enters the information found in the EOP into their PMS or HIS to accurately reflect the payer's disposition of the claim against the patient's account
   [symbol] The provider keys in the VCN in their card acceptance point of sale (POS) terminal. The POS is obtained from the Provider's bank, and is used to accept card payments from consumers and payers.
   [symbol] Although paper EOP's and VCN's are expensive to generate and the most manually intensive (and in some cases expensive) to post, it represents an accurate way to link payment with remittance. This is based on the simple fact that both the VCN and EOP are received together.
vi. Option 4: In yet another example of how remittances are transmitted by payers to providers; a Payer may generate a paper EOP, however payment is transmitted electronically.
   [symbol] The EOP is generated by the Provider's system
   [symbol] The EOP is mailed to the Provider
   [symbol] The healthcare Provider receives the EOP and manually enters the data into their PMS or HIS
   [symbol] The healthcare Provider expects receipt of an electronic funds transfer usually processed by ACH (as reflected in FIG. 1; Option 4a). It should be noted that the same trace number mismatch problem exists as described in option 1 & 1A.
vii. Option 4A: In example 4, Payers will generate an ACH electronic funds transfer to provide the payment funds associated with the EOP.
   [symbol] To generate an ACH, a payer creates an ACH instruction. The ACH instruction typically includes the Provider's name, the Provider's bank information, the Provider's bank account information, and the date on which to send payment
   [symbol] The ACH instruction is transmitted to the Payer's bank for processing
   [symbol] The Payer's bank transmits the ACH from the Payer's account based on the instructions received. With every ACH transaction, an ACH trace number is created by the payer's bank, and serves as an identifier for the transaction. This trace number is different than the trace number generated by the payer. Trace numbers are typically unique, 15 digits long and contain numeric values. In essence, the trace number is a token, which serves to identify or link the funds received to the corresponding EOP.

The essence of the problem with the EOP & ACH process is discussed above.

The Payment & Reconciliation Processes:

There are basically three payment modalities—Physical check, Virtual Cards, and ACH. The reconciliation processes are as follows:

Physical check payments:
Although archaic by most standards, the core of the reconciliation process resides in the physical receipt of the paper explanation of payment (EOP) along with the attached check from the insurance company.
The physical check is attached to the last page of the remittance advice.
The attachment of the check to the remittance allows the Provider to ensure that the amount paid matches the exact amount of what the remittance received dictates, b) payment was in fact received, and c) the payment received is applied correctly.

Payment Cards/Virtual Card payments and the reconciliation process:
Over the last five years, a trend of replacing checks with payment cards supported by the major payment networks (MasterCard, Visa, American Express, PayPal, et. al.) has arisen.
Although the cards can manifest themselves physically similar to the plastic cards issued to consumers, the overwhelming majority are commonly referred to as Virtual Cards, whereby a picture of a card is attached to the bottom of the EOP sent to the Provider (in place of the physical check), with a corresponding 16-digit number (the “Virtual Card Number” or “VCN”), expiration date, CVV2 (card verification value—“security code”) number and authorization amount. Practically, the VCN is a token assigned by the payment card networks, and is used as part of their standard processes and work-flows to authorize payments electronically. An example is included in the image below.
Upon receipt of the Virtual Card, the Provider or administrator enters the card number (along with the amount and other data attributes provided) into their POS system as they would if a person was paying with a physical plastic credit card. As with a credit card transaction, an approval code is generated and payments are transmitted to the Provider's bank account. The card issuance and processing workflow will be further described in the invention section, however, in its simplest form, a virtual card is exactly the same as (in fact is) a credit or debit card, and is processed the same way as an online card payment on Amazon or when a card payment is made over the phone.

ACH payments and the reconciliation process:
When ACH transactions are initiated by a Payer, they imbed the date they initiated the payment instruction to their bank within either the EOP or the 835 transaction.
Although this date is accurate in terms of when the payer notified their bank of the desire to transfer funds, it rarely correlates to the date funds are actually withdrawn from the Payer's account and almost never corresponds to the date the Provider receives the funds.
Furthermore, Payers do transmit identification/tracking information to their banks for inclusion within the ACH data segments with the intention of creating a reconciliation cross reference to the remittances they are transmitting. However, the Payer does not control where the tracking information is placed within the ACH record, and almost never has control or access to the trace information associated with the ACH generated by the transmitting financial institution. The end result is either a completely disjointed attempt at linking the remittance record with the ACH funds, or tracking information that is very costly to extract from initiating and receiving banking systems.
Several attempts have been made to automatically calculate the “effective date” of the transfers, or the date on which funds should appear in the Provider's bank account based on known transfer timings and fund holds within banks.
Those approaches inevitably create further reconciliation complexities as disparate bank processes or missed fund transfer windows generate erroneous dates that send providers on proverbial wild goose chases trying to find transactions that haven't appeared when they were calculated to.
As an attempt to make these disjointed processes functional, sophisticated or financially capable Provider institutions have invested heavily in their technology platforms to a) build customized mapping capabilities for each payer that submits electronic transactions, and b) directly integrate their systems with their banking providers to be automatically notified upon ACH receipt and extract the data elements embedded within each ACH transaction.
One of the biggest limitations of those investments is that any systemic change initiated by either the Payer or the Bank even for simple routine maintenance results in a complete breakdown of the customized integration and technology processes developed by the Providers for the electronic transactions.
Notwithstanding the complexities of administering the ACH processes, when electronic straight through processing is successfully deployed, processing costs fall by over 65%, and the absolute volume of transactions falls by 56%
   The Costs Associated with Payment Processing in the US Healthcare System:

The costs associated with healthcare payments starts with Payers and transcends into the Provider workflow. Because there are multiple payment modalities in healthcare, each with its own sets of considerations, it is important to review each method independently.

Costs Associated with Checks:
Checks originate from Payers, typically with one check attached to each EOP if a payment amount is due as described above.
The process of generating checks involves a complex work-flow inclusive of the generation of:
   positive pay files for bank reconciliation,
   ledger accounting of each check number released for payment,
   dedicated check stock for each account which disburses funds, and
   highly complex interfaces with the print and fulfillment companies that physically print and mail the EOP's and associated check payments.
   The costs associated with this process are:
      bank charges to clear each check
      bank charges for each positive pay file that is generated
      print company charges for each sheet of paper (checks, EOP, envelopes, etc.) printed,
      print company charges for ordering and maintaining the various check stock profiles,
      postage, and
      general processing fees associated with the entire process.
      These costs do not include the internal costs incurred by Payers to research & follow-up issues, stop payments, void & reissue checks, manage over payments, etc.
Costs continue to be incurred by Providers who receive the checks. When Providers receive checks, depending on volume, they incur:
   lockbox fees,
   armored car service fees,
   scanning and imaging charges which enable electronic storage of the check and EOP
   manual keying costs,
   bank deposit fees, and
   employee costs associated with receiving and processing the checks.
Despite all of these costs, the Provider's preference to receive payment via check vs. electronic form is due to the ability to associate each payment with the specific claim and claim adjustments, something that is difficult when receiving payment via ACH. (See electronic payments below).
   Costs Associated with Payment Cards/Virtual Cards (VC):
Virtual cards, in their current incarnation, eliminate check processing fees and special paper stock costs.
Outside of the check specific costs, the costs associated with a paper based EOP work-flow are the same as in the check process.
In addition, Providers continue to incur internal costs with the handling of physical payment forms (similar to those associated with checks).
Although the Providers do save on check related bank charges, they are replaced with payment card processing costs (as high as 5% of the payment amount), which are charged by the merchant banks who facilitate the acceptance of credit and debit card transactions (issuance, clearing, settlement, processing). In their current form, VC processing costs generally well exceed those specifically related to checks.
In summary, the costs of the Virtual Card process wind up being the same or greater as under the check process with the exception that some costs are shifted between the Payer and the Provider (Payer no longer pays check printing costs, Provider saves on check processing but incurs payment card transaction costs).
In essence, this process is not a material improvement and, because of the cost shifting, Providers are beginning to reject payment using this method and it will, in all likelihood, not gain meaningful traction.

### Costs Associated ACH Payments:

The costs involved in processing ACH's are broken into two buckets: a) per item transactional charges and b) reconciliation related investments and work-flows
Transactional fees associated with ACHs are nominal, based on a long and well invested clearing system between financial institutions. At scale, typical per item fees can be as low as $0.015-$0.06.
ACH transactions also eliminate most if not all the expenses associated with manual handling of payments including security, scanning, imaging, fraud, card payment network interchange, deposit and clearing fees, etc.
Costs associated with developing customized per payer reconciliation processes and ongoing maintenance can be exorbitant, ranging from several thousands of dollars to well over one million dollars.
The unfortunate realities of ACH transactions are that the upfront investments and ongoing maintenance requirements (monitoring and adjusting to changes) serve as significant barriers to what could be very efficient and cost effective payment processing in healthcare and are, as a result, used primarily where Medicare is the Payer.

### SUMMARY OF THE INVENTION

Briefly, an improved system to connect ACH payments to 835 EDI transmissions in order to electronically reconcile payments to remittances and to do so with a payment process that establishes a “Trusted Counterparty Network” such as a limited access credit & debit card network, or a closed loop ACH payment network.

The objective is to configure a process or work-flow that allows detailed remittance data to post electronically, payments to be submitted for authorization and approval in real time, ensure the Provider's PMS or HIS can easily reconcile the funding with specific 837 forms, and fund and settle transactions with minimal human intervention.

The system uses existing platforms, tools and connections already established in the industry and utilized by payers and providers; banks and payment networks; software solution providers and payment service providers. However, by leveraging trusted counter parties, the Provider is effectively able to convert the current ACH push process initiated by the payer, to a pull process initiated by themselves, such that the Provider only pulls funds from payers once they have posted the 835.

This connection will (1) allow Providers to tie payments to 835 details electronically without specific Provider/Payer integrations, (2) eliminate counterparty risk associated with healthcare payments, and (3) remove billions of dollars of non-patient facing costs from the US healthcare system.

### DESCRIPTION OF THE DRAWING

These and other advantages of the present system will be readily understood with reference to the following specification and attached drawing wherein:

FIG. 1 is an exemplary flowchart of the process from initial healthcare service through receipt and reconciliation of payment.

FIG. 2 illustrates an exemplary method of embedding a token within an 835 remittance to be paid.

FIG. 3 illustrates an exemplary method of transmitting the 835 with Embedded Token.

FIG. 4 is an exemplary diagram that illustrates How Merchants Take Control of Funding with Trusted Counter Parties.

FIG. 5 is an exemplary diagram that illustrates how counter parties are used in the System to authorize and settle payment.

FIGS. 6A-6G illustrate an exemplary diagram of an electronic 835 EDI message illustrating data fields, data elements, and data requirements with a sample trace number embedded in field TRN segment in accordance with the invention.

FIGS. 6H-6M illustrate an exemplary diagram of an 837 EDI message illustrating data fields, data elements and data requirements.

### DETAILED DESCRIPTION

The present system relates to a healthcare payment network for facilitating reconciliation of a remittance with an originating claim. The core of the idea is to modify the systems and the processes to generate a unique (reusable or recyclable) token for each payment from a given Payer. In one implementation, the token is a 16-digit numeric VCN or 15 digit numeric ACH Trace Number which would be generated using current solutions which operate with card payment networks (e.g. Visa, MasterCard, American Express) or ACH networks. The VCN or ACH Trace Number will serve as a token to match the 835 to the payment for reference and reconciliation purposes and it will also be used to authorize payment using the respective payment network. Automated Clearing House (ACH) is an electronic network for financial transactions that processes large volumes of credit and debit transactions in batches.

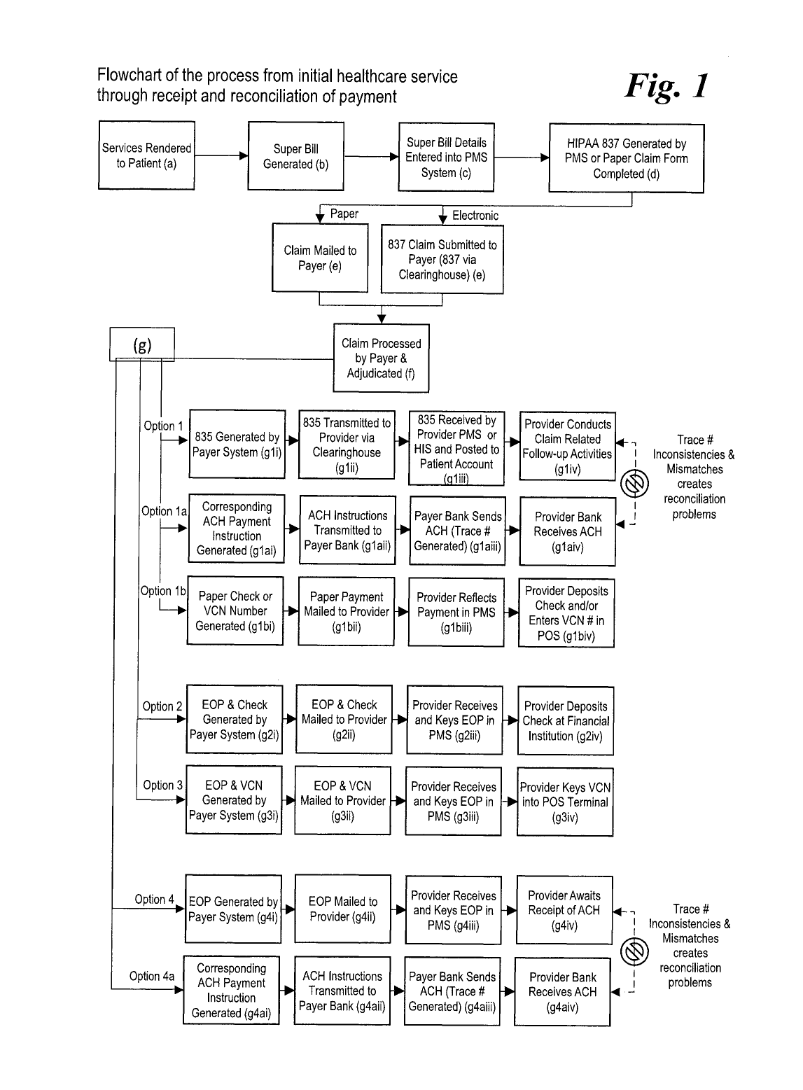

In the system in accordance with the invention, a card payment or ACH network, gives the Provider the ability to safely and securely transfer funds via a counterparty enabled “pull” from the Payer's account to the Provider's account. Furthermore, because they use a token which has been embedded in the remittance to claim (pull) the funds, there is never a mismatch between the token the Payer has embedded when the remittance is generated and the funds that are being deposited. This squarely addresses the status quo limitation that push ACH payments create when both the Remittance and Funds transfer are unilaterally initiated by the payer, and the linking trace number information is disjointed as described in FIG. 1. In the current system, the Provider is unable to link and reconcile both the 835 and ACH payment.

The ability to generate unique Tokens is a current capability of the major payment networks. Visa, MasterCard and American Express (“the Card Networks”) have created algorithms by which credit and debit card numbers that operate within their networks are generated, and the ACH system has developed algorithms by which member banks generate trace numbers that operate within the ACH framework.

The Card Networks have enlisted banks, who serve as issuers of debit and credit cards to both individuals and business entities, into their ecosystems. Each bank is assigned an identifier that is typically located within the first 4-6 digits (BIN number) of the card numbers generated. Each remaining digit within the string of the collective VCN is governed by a rule set of how it is assigned. Examples of card issuers include: Chase, Citibank, Wells Fargo, US Bank. One of Chase's BIN numbers with Visa is 4226.

The ACH network has enlisted participant banks, who serve as originators (ODFI—Originating Depository Financial Institution), and receivers (RDFI—Receiving Depository Financial Institution). Chase, Citibank, Wells Fargo and US Bank are also both ODFI's and RDFI's in the ACH Network. The ACH network has defined a 15-digit numeric algorithm to create trace numbers, and have dictated the rules by which a trace number is applied to an ACH transaction and reflected in banking registers.

Banks typically leverage the service of Issuing Card Processors (e.g. TSYS, First Data) or card management platform Providers (e.g. AOC), to both generate and maintain the inventory of cards and their associated numbers (tokens). In the ACH system, Banks either service and process their own transactions or enlist the services of 3^{rd} Party ACH Transmitters. In either case, readily available solutions exist like those offered by SunGard, which creates ACH transmission files known as NACHA files (National Automated Clearinghouse Association), or payment validation files known as Positive pay files. ACH transactions usually assign 15-digit numeric trace numbers to each fund transmission.

Banks also leverage Issuing Card Processors to connect to the Card Networks, while assigning an available balance which each card can be authorized against (known as credit line, fund availability or Open to Buy). The balance is either a reflection of the funds on deposit with the bank (debit cards), or the credit line assigned to the card holder by the banks underwriting unit. In the ACH system, banks leverage ACH Operators (central clearing facilities), which are usually either the Federal Reserve or The Clearing House). The ACH system works off a good fund model which means that the money to be transmitted is on deposit with or is readily available to the ODFI before a transaction is initiated.

As this infrastructure is in place and operational on a major scale, it would be used. This capability is not being applied effectively to the healthcare payment system for the objectives described above, as all current manifestations are either manual, or have a flow of funds that is incompatible with effective reconciliation and linkage.

### Embed the Unique Token into an Unused Data Field in the 835

Currently, the electronic 835 (as compared with the physical EOP) does not consistently, reliably or adequately carry meaningful linkage to the electronic payment (virtual card, ACH or wire) directly. It does carry the patient number [and other identifying information such as patient name, date of service, services rendered] which is used when the Provider is reconciling payment and remittance information manually. This is one of the reasons checks, and the current deployment of virtual cards are printed out and attached to the EOP's which are sent physically to the Provider.

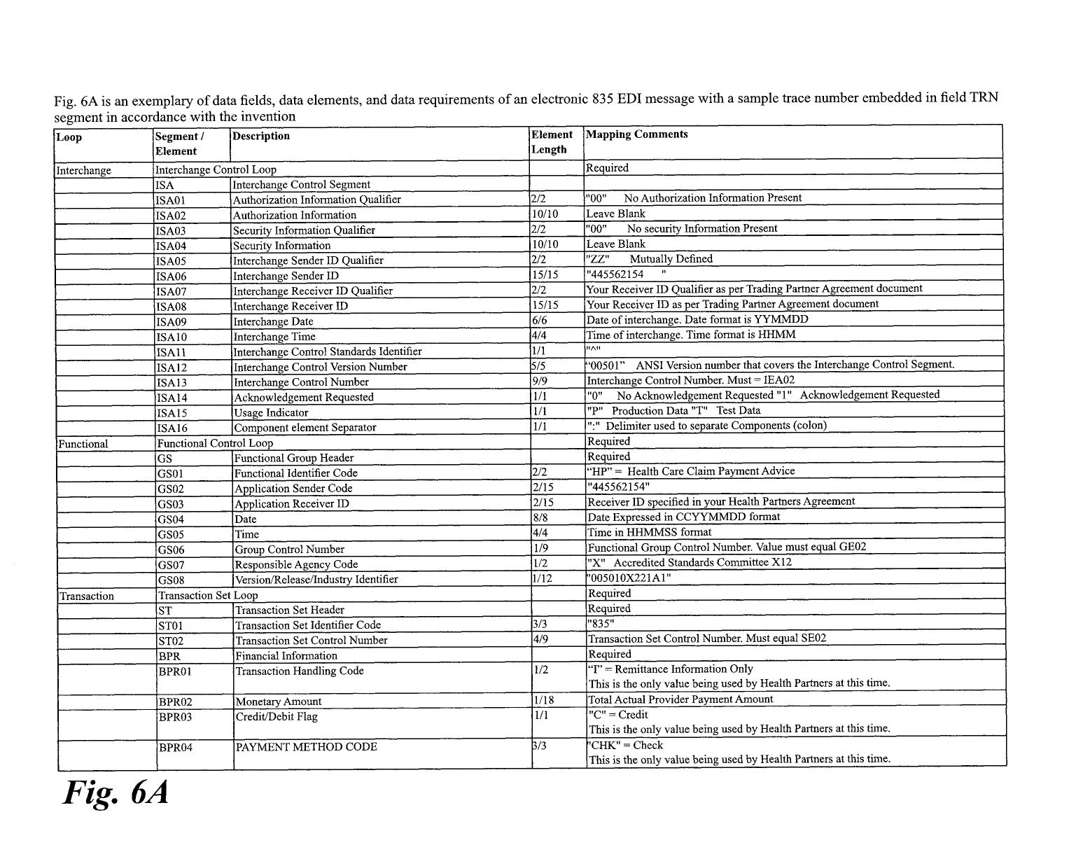

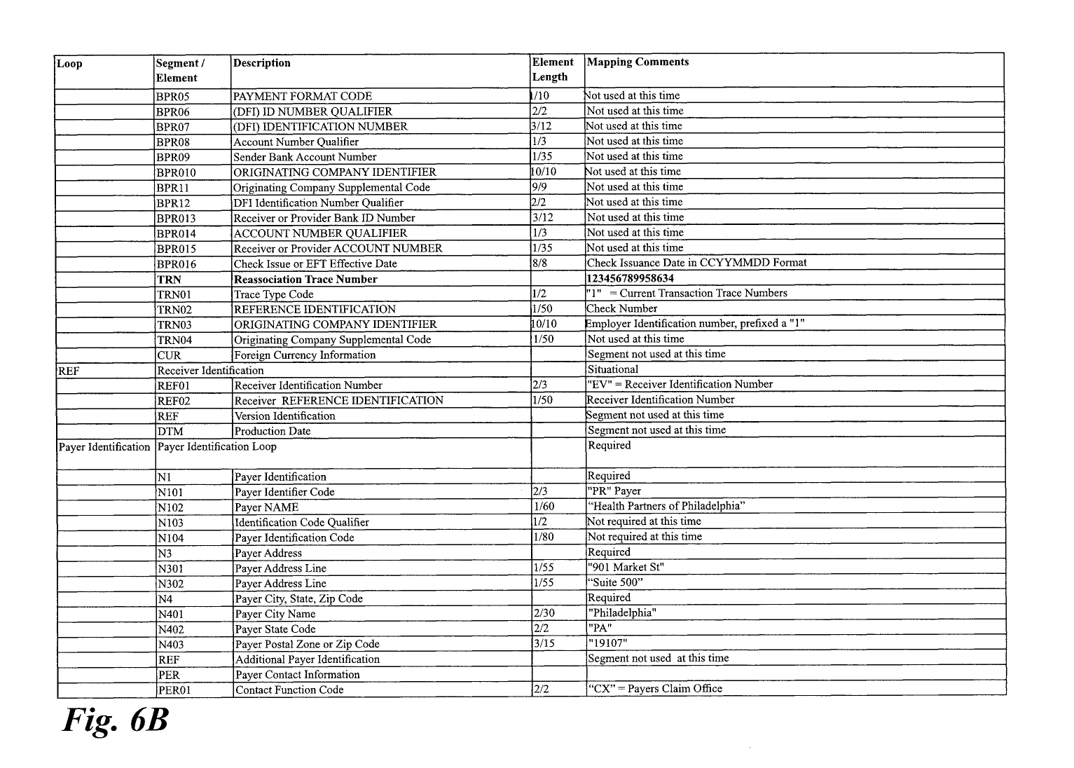

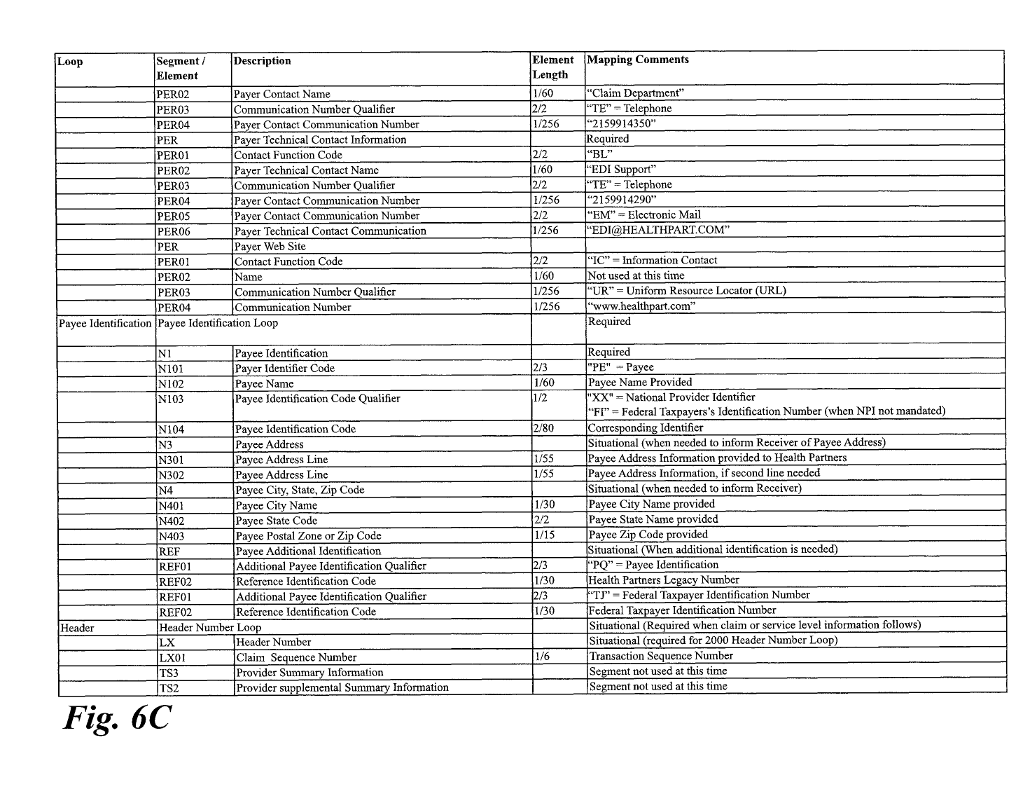

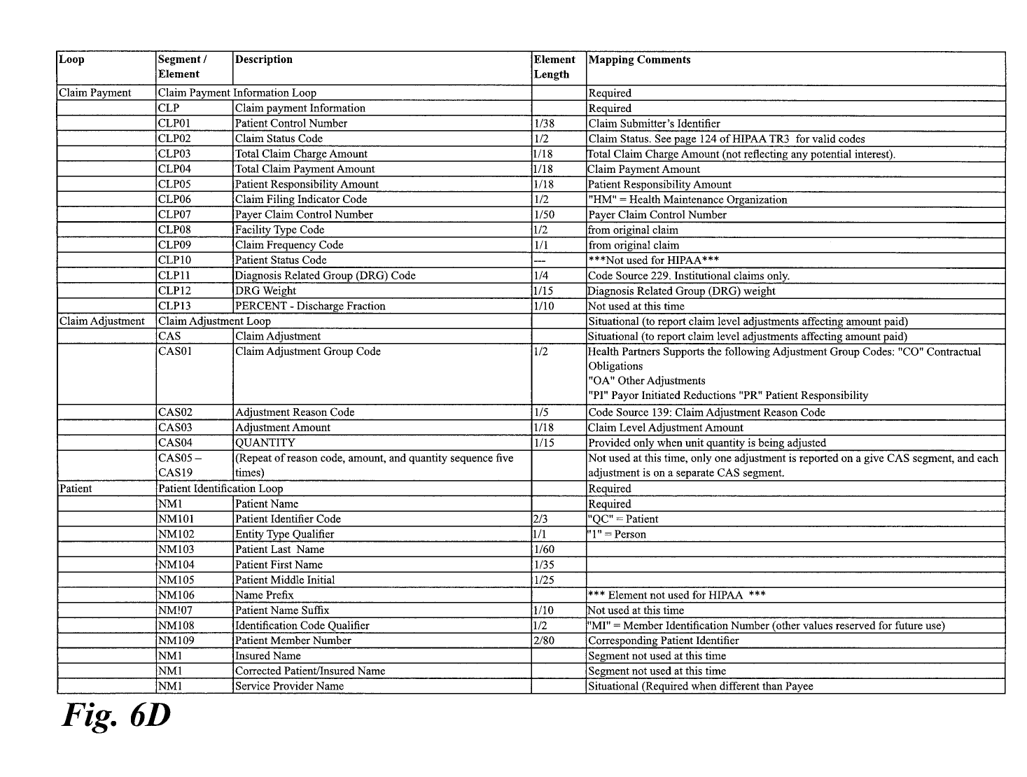

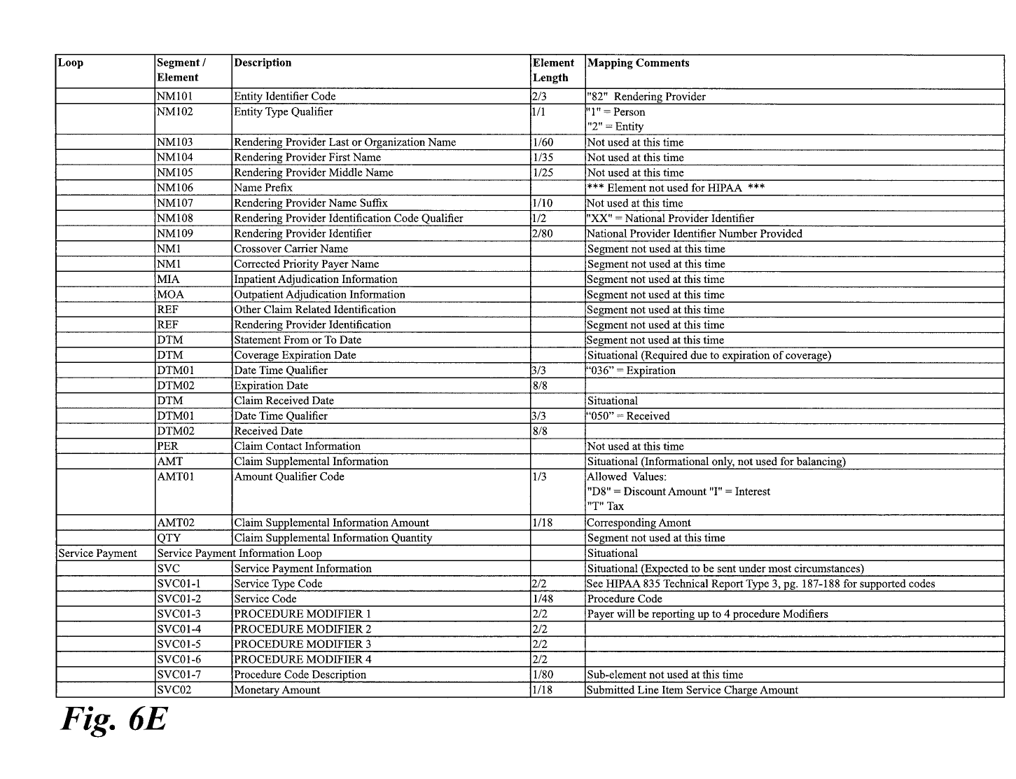

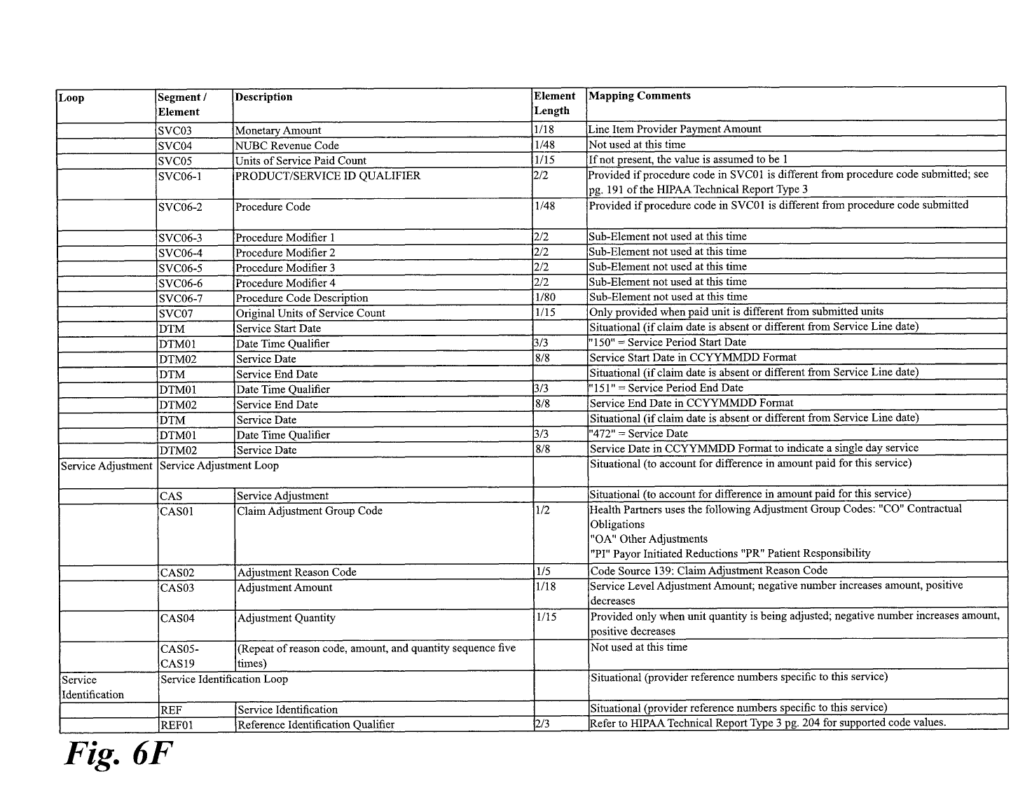

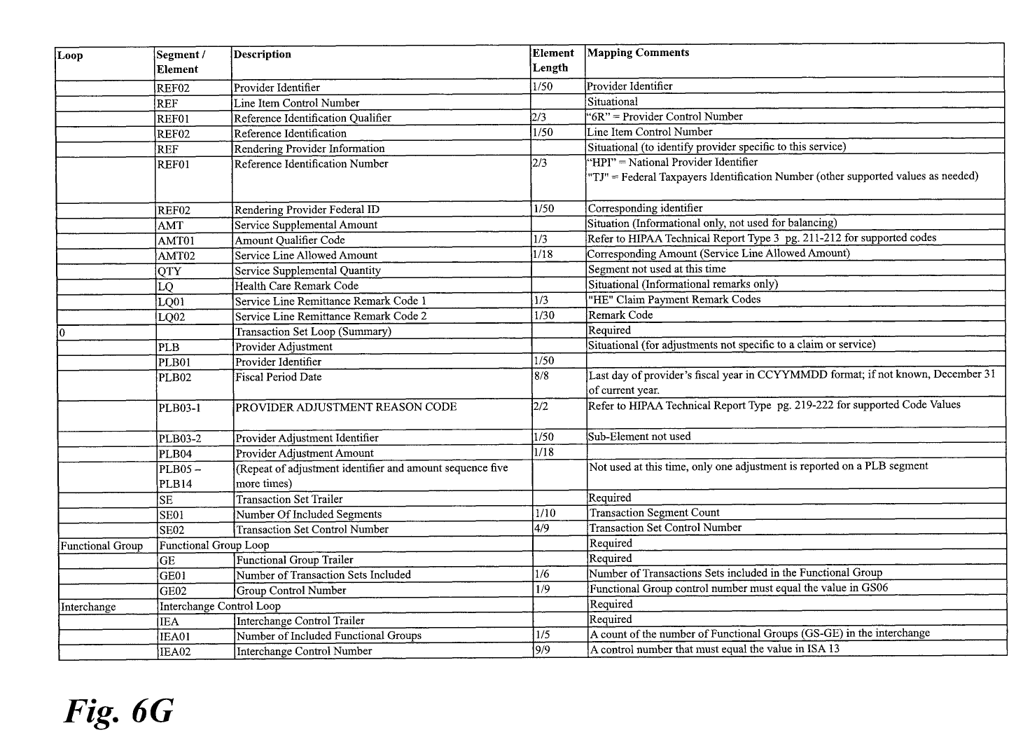

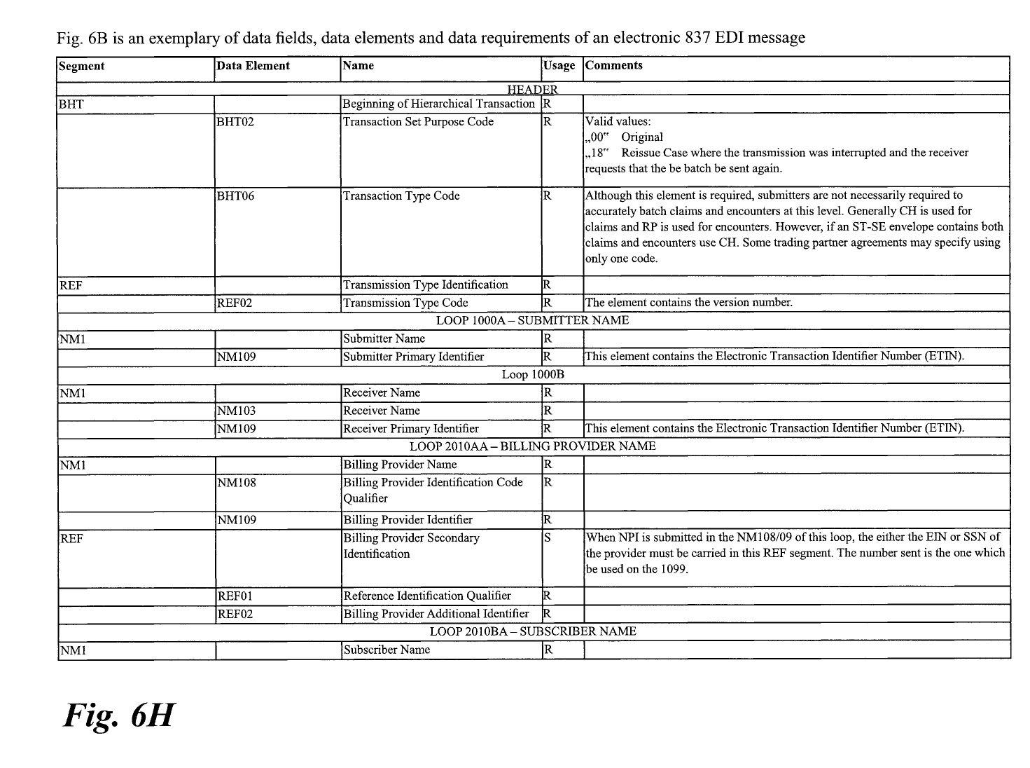

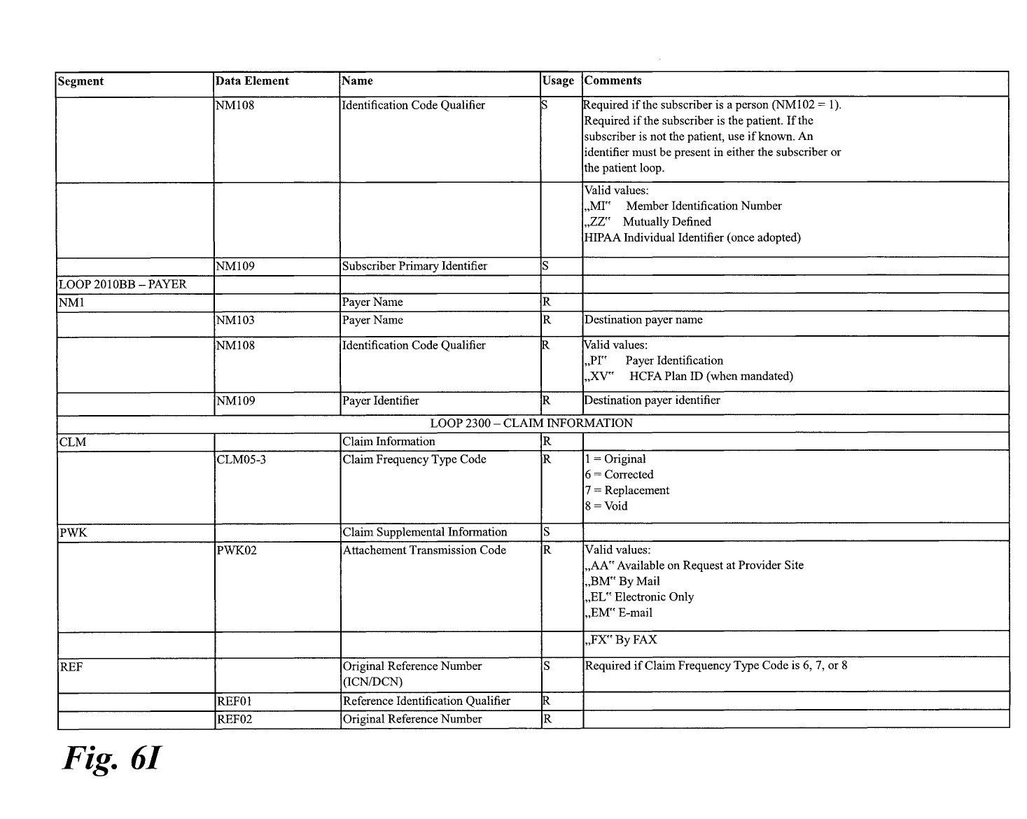

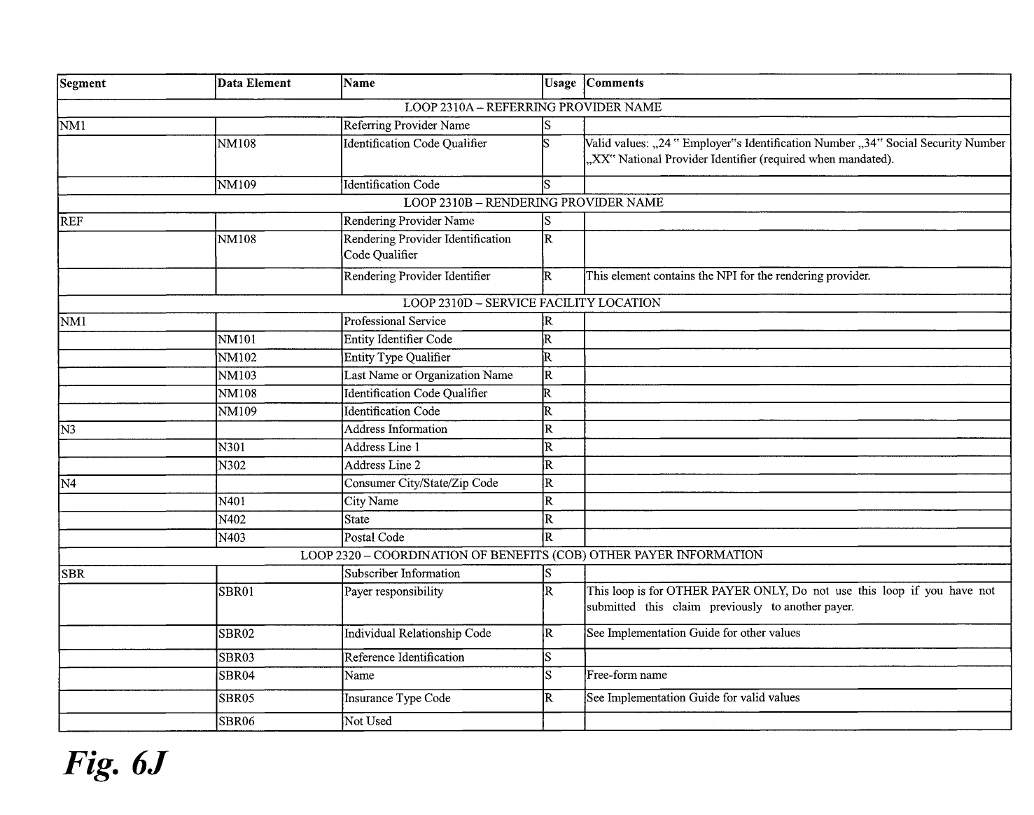

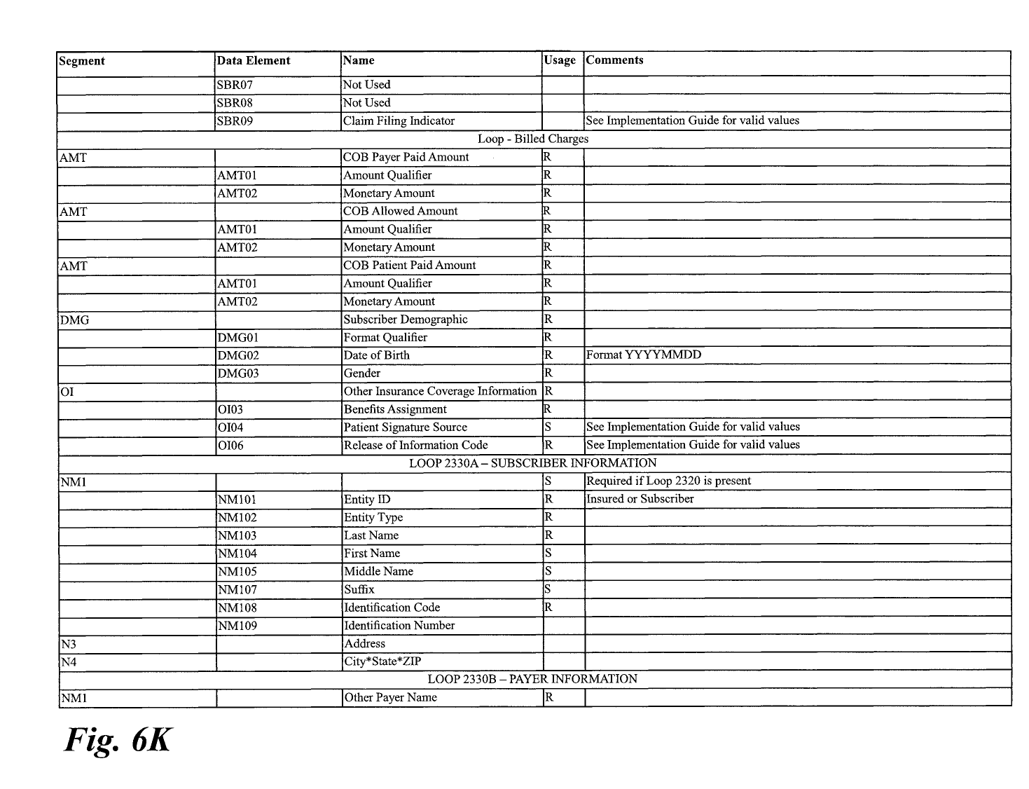

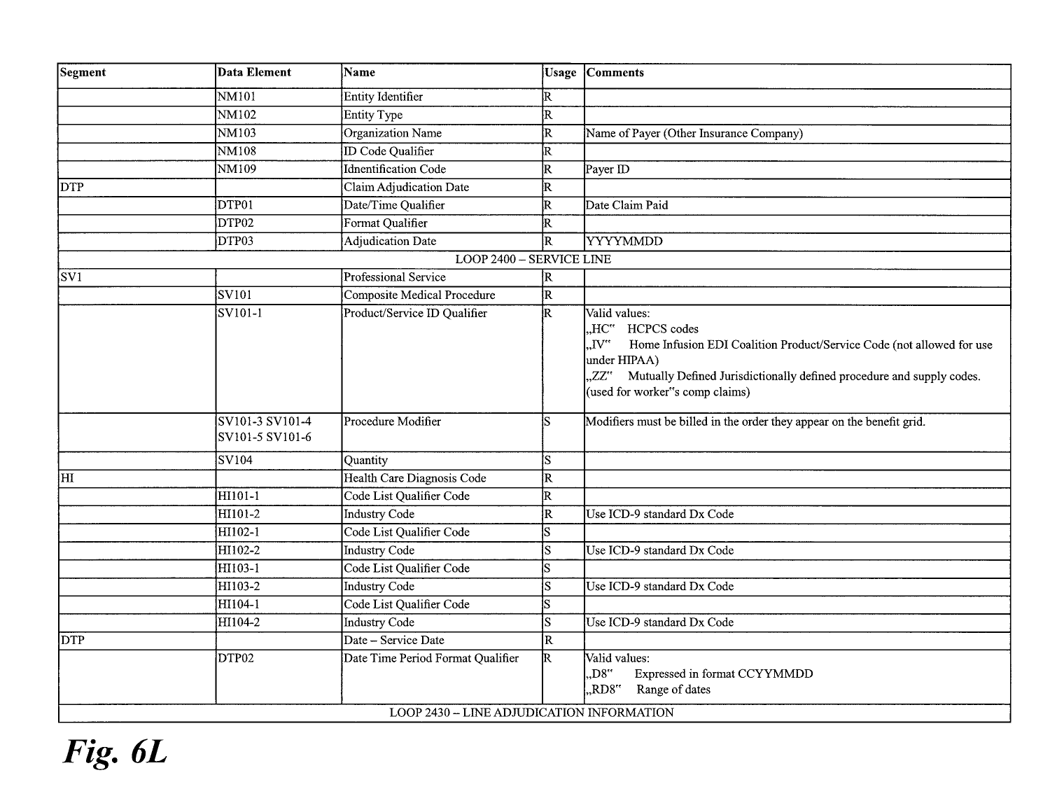

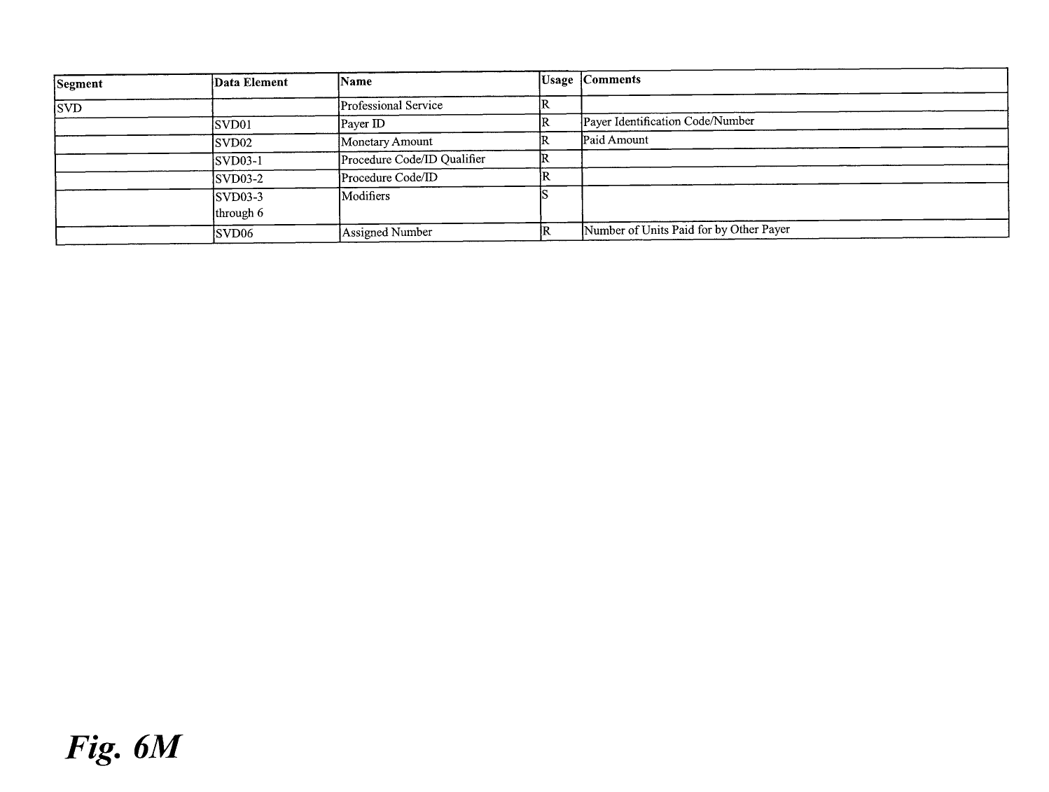

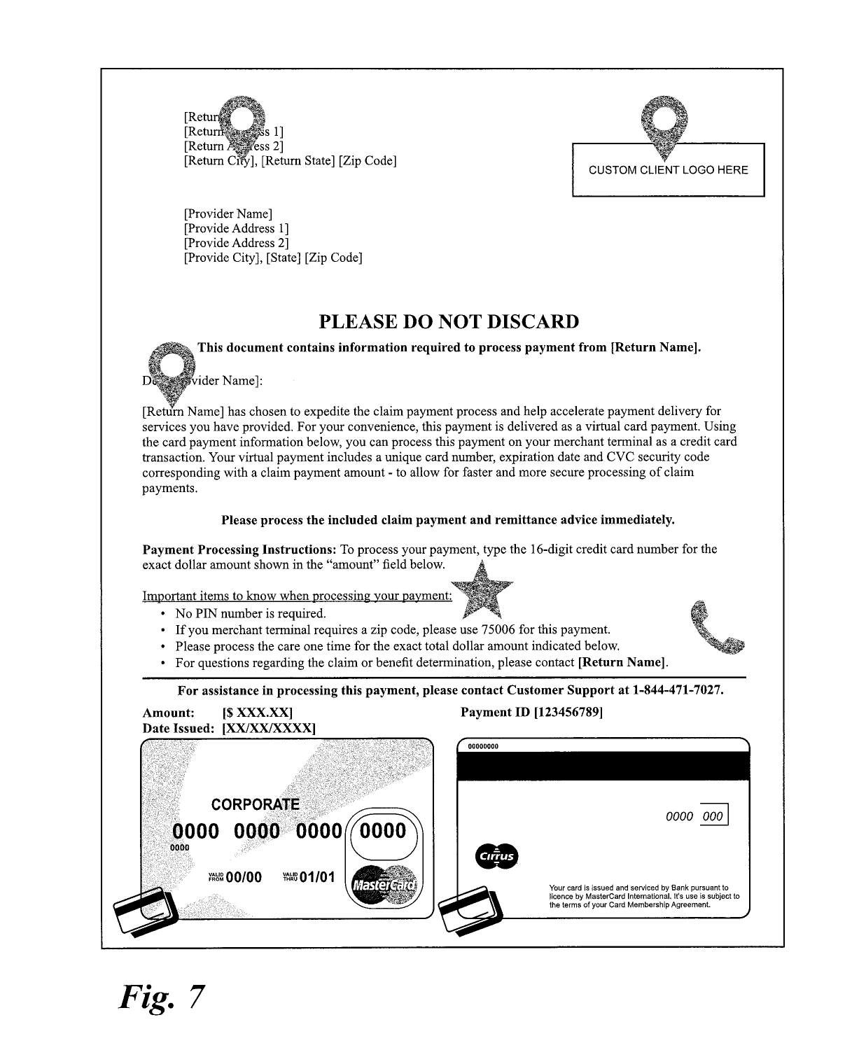

The HIPAA 835 remittance has several payment related segments, which can house the token information (either the 16-digit numeric VCN or 15 digit numeric ACH trace number), or alternatively can be imbedded within reserved payment segments of the standardized 835 remittances (specifically the TRN segments of the 835). See FIG. 6A which illustrates an exemplary 835.

The only relevance of where the number is placed within the 835, is that of identification by the receiving Provider PMS or HIS, which will need to extract the token for authorization. This placement can either be pre-defined or chosen on a Payer by Payer basis. The specific segment of the 835, where the token is embedded is identified to the various PMS and HIS platform providers (or the healthcare Providers themselves) either via bulletin, public disclosure, header record identifier within the 835 itself, or by a mandate from the 835-governing committee. The only pre-requisite is that the placement and format of the token follow a constant rule set, which can be systemically coded to for extraction and authorization submission. Currently, it is expected that the token will placed in either the TRN, TRN01, TRN02 or TRN03 segments of the 835 layout. An example of a 16 digit VCN token is 4147658963256532 or a 15 digit ACH token trace number is 542387496125634

In one implementation, the token would either be via VCN or ACH Trace Number. The Payer may either obtain a license from a bank to self-generate tokens within a prescribed range and in compliance with the Bank's card issuing or ACH trace number algorithms; or systemically pull card numbers [tokens] from the Bank's card management platform (e.g. AOC) or ACH Trace Numbers from 3^{rd} Party ACH solution providers (e.g. SunGard); or obtain an inventory of virtual card numbers [tokens] from the Bank which is refreshed from time to time. The VCN or ACH token would be transcribed and embedded in one of the 835 TRN segments.

In one implementation, one of a number of Remittance and Payment Solution Providers (“RPSP”s e.g. Echo, VPay, RedCard) may oversee the obtaining, issuance and embedding of Tokens into the 835 on an outsourced basis (on behalf of industry Payers). For this, the RPSP would either obtain a license from the Bank to self-generate tokens within a prescribed range and in compliance with The Bank's algorithms; systemically pull tokens from the Bank's token management platform (e.g. AOC) and/or issuing processor (e.g. TSYS); or obtain an inventory of tokens for this effort from the Bank, refreshing this inventory from time to time.

Many Payer systems assign a payment reference ID upon claim adjudication (e.g. a check number 1234) and so it may be necessary to maintain a cross reference database of check numbers to newly assigned Tokens to ensure proper and effective reconciliation within the Payer's accounting processes.

### Modify the Payer's Claims & Payment System(s) to Carry the Embedded Token

In one implementation, each Payer may modify its claims system to embed the Token together with the other data elements located in the 835-electronic remittance. This is not a difficult task as, and, if requested, the systems platform company can perform this relatively minor modification on behalf of its clients.

Alternatively, the Payer can follow their current processes as they do today, and generate the 835-remittance advice. They can forward the 835 on their own or at the direction of the receiving healthcare Provider to an RPSP who will insert the VCN or ACH token into the appropriate TRN segment of the 835. If convenient and/or required by the Payer, the RPSP can also maintain a cross reference database of Payer Payment ID's to Tokens generated.

Another benefit of this process would be to get the entire payer community on a common disbursement structure that eliminates the customized nature of proprietary banking relationships that creates the disjointed structure of many to many relationships.

### Provision an “Open to Buy”

For VCNs the Payer or their RPSP transmits an available amount associated with each token id to the Issuer (e.g. Chase) and/or their designated Issuer Processor (e.g. TSYS). For ACH transactions, the Payer or their RPSP transmits an available amount associated with each token id to their bank or ACH payment services provider. The available amount is equal to the amount to be paid per the corresponding 835 remittance, and usually reflected in the BPR02 segment of the 835. Within the Issuer's system, this is known as an Open to Buy, and will serve as the authorization amount limit when the VCN is entered for authorization by the Provider's system. For an ACH, this is known as the Amount, and typically located within the 30^{th} to 39^{th} field positions of the NACHA file. If a positive pay file is used, the amount will be placed in any field mutually agreed to between the two parties.

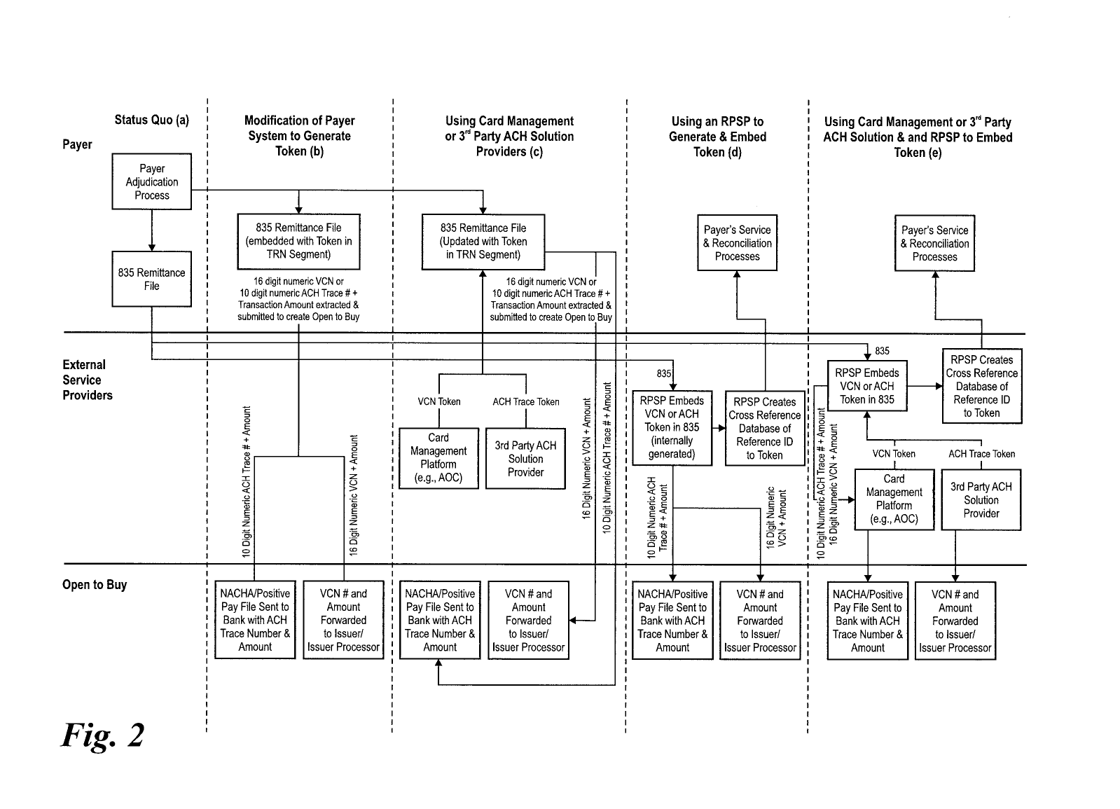

FIG. 2 shows the process of embedding a token within an 835 remittance to be paid and the provisioning of an Open to Buy
a. Status Quo: Expanding on box (f) of FIG. 1, the Payers system adjudicates the claim submitted by the Provider as they do today
   i. The payer's system creates an 835-remittance file
b. Modification of Payer System to Generate Token
   i. The payer modifies their adjudication system, such that when an 835 remittance is created, the TRN segment is populated with either a 16 digit VCN token or a 15 digit ACH trace number
   ii. For an ACH token, the payer takes the trace number and 835 payment amount and submits it to their bank via electronic file. Two examples of this file are a NACHA file or a Positive Pay file. In this case, the NACHA file is not used to transmit funds from the Payer's bank, however it will be used at a subsequent step to validate that a debiting ACH transaction is valid. A debiting ACH is originated by the customer of the RDFI and pulls funds from the account of the ODFI customer (the Payer). A Positive Pay file can be any utilized electronic readable file, and serves as a payment inventory validation tool. It contains all transaction amounts and associated identifiers (e.g. Trace numbers or tokens) which a buyer considers to be valid, which a bank uses to validate against every transaction which is presented for payment.
   iii. For a VCN token, the payer takes the trace number and 835 payment amount and submits it to their bank card issuer or bank card processor via electronic file.
   iv. For both the ACH and VCN, the transmission of the token and amount by the Payer creates the “Open to Buy” in the bank system or the bank issuer/processor system. In a subsequent step of the process, these Open to Buy's will be used to validate the legitimacy of the transaction, and initiate the transfer of funds.
c. Using Card Management or 3rd Party ACH Solution Providers
   i. The payer modifies their adjudication system, such that when an 835 remittance is being created, a VCN or ACH token is requested from an external solution provider, which will be placed in the TRN segment of the 835.
   ii. For a VCN token, the payer system will request a VCN from a card management platform or solution provider such as AOC
   iii. For an ACH token, the payer system will request an ACH trace number from a 3rd party ACH solution provider such as SunGard.
   iv. When the tokens are provided by either the VCN or ACH provider, it is embedded in the TRN segment of the 835 by the Payer
   v. For a VCN token, the payer takes the trace number and 835 payment amount and submits it to their bank card issuer or bank card processor via electronic file.
   vi. For both the ACH and VCN, the transmission of the token and amount by the Payer creates the “Open to Buy” in the bank system or the bank issuer/processor system. In a subsequent step of the process, these Open to Buy's will be used to validate the legitimacy of the transaction, and initiate the transfer of funds.
d. Using an RPSP to Generate & Embed Token
   i. The payer generates the 835 file as they do today, and forwards it to an RPSP. In some cases, the services of an RPSP are used to create the actual 835 in a HIPAA compliant format. In this case, the file created by the payer adjudication system is similar to an 835, in that it is in electronic form and contains the data elements necessary to create an 835, however it is not compliant with the specific standards of HIPAA (usually a violation of format or content rules makes it non-compliant).
   ii. The RPSP modifies their current remittance file system, such that when an 835 remittance is created or received, the TRN segment is populated with either a 16 digit VCN token or a 15 digit ACH trace number
   iii. The RPSP may also create a cross reference table of the token embedded in the 835 with the Payers existing payment reference number if it is included in the file they received from the Payer. The purpose of this process is to provide the Payer with the ability to match the token with the payment reference number in their systems for customer service or reconciliation purposes.
   iv. For an ACH token, the RPSP takes the trace number and 835 payment amount and submits it to their (or the Payer's) bank via electronic file. An example of this file can be a NACHA file or a Positive Pay file. The NACHA file is not used to transmit funds from the Payer's bank, however it will be used at a subsequent step to validate that a debiting ACH transaction is valid. A debiting ACH is originated by the customer of the RDFI and pulls funds from the account of the ODFI customer (the Payer).
   v. For a VCN token, the RPSP takes the trace number and 835 payment amount and submits it to their (or the Payer's) bank card issuer or bank card processor via electronic file.
   vi. For both the ACH and VCN, the transmission of the token and amount by the Payer creates the “Open to Buy” in the bank system or the bank issuer/processor system. In a subsequent step of the process, these Open to Buy's will be used to validate the legitimacy of the transaction, and initiate the transfer of funds.
e. Using a Card Management or 3rd Party ACH Solution & an RPSP to Embed Token
   i. The payer generates the 835 file as they do today, and forwards it to an RPSP. In some cases, the services of an RPSP are used to create the actual 835 in a HIPAA compliant format. In this case, the file created by the payer adjudication system is similar to an 835, in that it is in electronic form and contains the data elements necessary to create an 835, however it is not compliant with the specific standards of HIPAA (usually a violation of format or content rules makes it non-compliant).
   ii. The RPSP modifies their current process, such that when an 835 remittance is received or being created, a VCN or ACH token is requested from an external solution provider, which will be placed in the TRN segment of the 835.
   iii. For a VCN token, the RPSP will request a VCN from a card management platform or solution provider such as AOC
   iv. For an ACH token, the RPSP will request an ACH trace number from a 3rd party ACH solution provider such as SunGard.
   v. When the tokens are provided by either the VCN or ACH provider, it is embedded in the TRN segment of the 835 by the RPSP
   vi. The RPSP may also create a cross reference table of the token embedded in the 835 with the Payers existing payment reference number if it is included in the file they received from the Payer. The purpose of this process is provide the Payer with the ability to match the token with the payment reference number in their systems for customer service or reconciliation purposes.
   vii. For an ACH token, the RPSP takes the trace number and 835 payment amount and submits it to their (or the Payer's) bank via electronic file. An example of this file can be a NACHA file or a Positive Pay file. The NACHA file is not used to transmit funds from the Payer's bank, however it will be used at a subsequent step to validate that a debiting ACH transaction is valid. A debiting ACH is originated by the customer of the RDFI and pulls funds from the account of the ODFI customer (the Payer).
   viii. For a VCN token, the RPSP takes the trace number and 835 payment amount and submits it to their (or the Payer's) bank card issuer or bank card processor via electronic file.
   ix. For both the ACH and VCN, the transmission of the token and amount by the Payer creates the “Open to Buy” in the bank system or the bank issuer/processor system. In a subsequent step of the process, these Open to Buy's will be used to validate the legitimacy of the transaction, and initiate the transfer of funds.

f.

### Transmit the 835 with the Embedded Token

Once a token has been embedded in the 835, and an open to buy or available amount is provisioned, the Payer transmits the 835 to the PMS/HIS directly, or via an intermediary clearinghouse (e.g. Change Healthcare, Relay Health) who maintains direct connections between the myriad of 3^{rd} party payers and the Nation's medical Providers.

835s are standard HIPAA messages, and as such almost all Provider PMS' are configured to electronically receive the remittances, extract the relevant data elements, and post them automatically to the appropriate patient accounts at a line item or claim level. For example, platforms such as Athena Health, eClinicalWorks, and EPIC routinely electronically receive 835 remittances on behalf of their Provider customers and users; parse the data fields of the 835; map the 835 data fields to the appropriate fields within their system's that generally correlate to the Provider's patient account fields; and extract the data to post within the corresponding fields of the patient account.

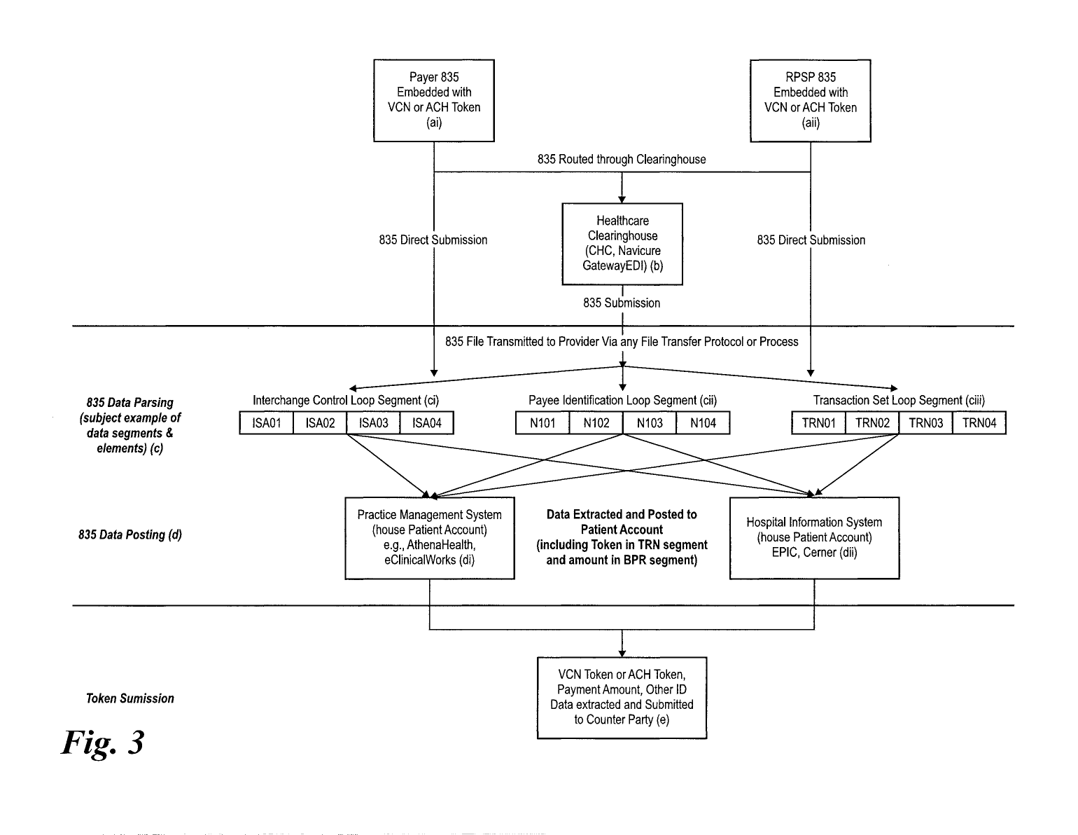

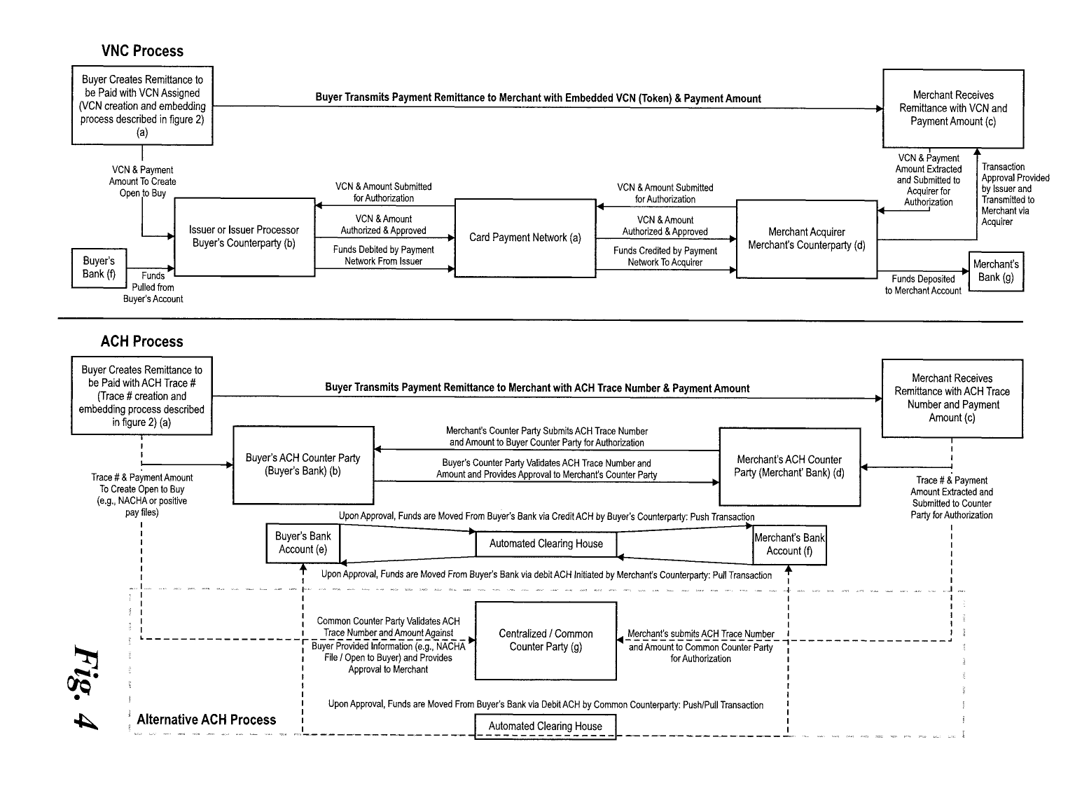

In a subsequent step, the system will modify the current 835 posting process performed by the Provider or the Provider's PMS/HIS platform to extract the embedded token, payment amount and other identifying information for submission and authorization via the Card Payment Networks or the ACH payment network. Prior to this, it is important to understand the introduction of counterparties within the system. FIG. 3 shows the transmission of the 835 with the embedded Token.
a. The token embedded 835 is generated as exemplified in FIG. 2 and is ready for transmission directly to the provider via the already established file transfer protocol
   i. In one example the Payer transmits the 835 directly to the Provider
   ii. In another example, an RPSP on behalf of a Payer transmits the 835 directly to the Provider
   iii. In another instance, the embedded 835 is generated by either the Payer or the RPSP, but is transmitted to a healthcare clearinghouse for subsequent transmission to the Provider via the already established file transfer protocol
b. The 835-remittance file is received into the Provider's PMS or HIS technology platform, and the data elements are parsed. There are over 100+ data elements, which map into over 10 data segments. Segments include:
   i. Interchange Control Loop segment;
   ii. Payee Identification Loop Segment; or
   iii. Transaction Set Loop Segment. This is the segment which houses the embedded Token in one example
c. The parsed data is posted to the patient account
   i. Provider's typically use Practice Management Systems where the parsed data will be posted
   ii. Hospital's typically use Hospital Information Systems where the parsed data will be posted.
d. The token, payment amount and other identifying information is extracted from the posted 835 remittances, and prepared for submission to the counterparty for payment

### Utilizing Trusted Counterparties

Introduce trusted counter parties (e.g. the card payment network, issuers, merchant acquirers, payment services providers, ACH service providers) to enable Providers to initiate the payment, rather than have Payers push funds directly to Provider bank accounts. The uniqueness of this concept is that it allows the Provider to initiate the funds transfer, when they are ready to receive payment, and following a process which specifically links the funds received to the remittance and patient account it belongs to. It also allows a provider to reconcile the patient account based on the received 835, and resolve any issues before funds are accepted and applied to the patient account.

In a generic sense, a counterparty based payment system allows unrelated or untrusted entities to transfer funds amongst each other while mitigating the risks of fraud, theft, or unauthorized payments. With card payment networks, there are two counterparties; and a centralized payment network that provides the fund settlement and governance for the transactions that take place over their network. One of the two counterparties are the merchant acquirer, who represents the merchant in the card payment system. The merchant acquirer validates that the merchant is a real and bona fide business to any buyer who wants to use a debit or credit card to make a purchase. The merchant acquirer also provides the merchant with the Point of Sale (POS) device or electronic connectivity (via API) to the card payment network. When a merchant takes a card for payment, the details of the card (e.g. card number) are transmitted to the Merchant Acquirer via POS or API connection, along with the amount to be authorized for payment. Acting as the agent of the Merchant, the Merchant Acquirer submits the card details and payment amount over the card payment network (e.g. MasterCard or Visa) for transaction authorization and subsequent fund settlement if approved. Conversely, the second counterparty, the Issuer (or the Issuer Processor) connect to the Payment Network and represent the buyer in the system. The Issuer provides the buyer with a payment card, which is used with Merchants to secure payment for goods and services. The Issuer's system authorizes a card number and amount submitted for payment by the Merchant Acquirer (via the payment network), provided the card number is valid, and the amount requested for authorization is within the limits available to the buyer (either by credit line or actual cash balance). If the Issuer provides an approval message to the Merchant Acquirer via the payment network, then the Issuer has guaranteed payment to the Merchant on behalf of the buyer. Of particular importance, the only entity that has access to the Merchant bank account is the Merchant Acquirer. Similarly, the only entity that has access to the Buyer bank account is the Issuer (or Issuer Processor). As such, the Merchant is able to receive payment without providing their banking details to the buyer, and the buyer is able to make payment without providing their banking details to the merchant. Furthermore, with this counterparty system, the merchant is able to link the payment request in real-time against the specific purchase which derived it. With today's card networks, transaction authorizations and transaction approvals typically take place in under 6 seconds. This process addresses the primary limitations of ACH processes that push payments by buyers to merchants directly into their bank accounts. It eliminates the need to provide the buyer with merchant bank account information, and it eliminates the need for the merchant to sort through all the deposits in their bank account across multiple days to confirm that monies have been pushed from the buyer account to the merchant account.

A similar counterparty system can exist for ACH transactions. There are two broad types of ACH transactions: a push or credit ACH transaction that is initiated by the buyer in a commercial setting; a pull or debit ACH transaction that is initiated by the merchant in a commercial setting. In today's process, the benefit of pushing an ACH for the buyer is that it protects against unfettered or unauthorized access to their bank accounts. When payments are due they initiate an ACH transfer from their account to the merchant account. The weakness of this model for Merchants is that they don't know the precise time when the funds will be received, they have to search their bank accounts to confirm that the funds were in fact sent, and they need to link each transfer to the purchase which it belongs to, in order to settle the account receivable. Conversely, the benefit of pulling an ACH in today's process for the merchant is that they are certain that the fund transfer was processed, they can initiate the transfer specifically against the account receivable, and they will know the precise timing of funding based on the relationship they have established with their bank. The weakness of the pull model for Buyers is that it provides unfettered access to their bank accounts, and will not inherently link to their account payable which it is settling without significant follow-up reconciliation activities. The limitations of either a Push or Pull ACH can be remedied with the introduction of a trusted counterparty, who can stand in on behalf of the merchants and/or the buyers. In this case, the buyer can supply the trusted counterparty with an ACH trace number (token) and amount which is authorized to be paid to the Merchant. The buyer would also transfer the funds to the Counterparty which will be used to settle the payment, or will provide the counterparty with the ability to debit their account for the necessary funds when the merchant requests payment. The trace number and payment amount can be provided to the counterparty via any file format, including a NACHA file or positive pay file. The buyer would then transmit a remittance to the buyer with the information related to the invoice it would like to pay (the accounts payable invoice), with an embedded ACH trace number (token) and amount it wishes to pay. When the merchant receives the buyer's remittance, it can extract the trace number (token) along with corresponding payment amount and submit it with its own account deposit details to the counterparty for authorization and fund settlement. When the counterparty validates that the trace number is accurate and corresponds to the amount authorized by the buyer, the counterparty transfers the funds which have been advanced to it by the buyer, or transfers the funds directly from the buyers account to the merchant account.

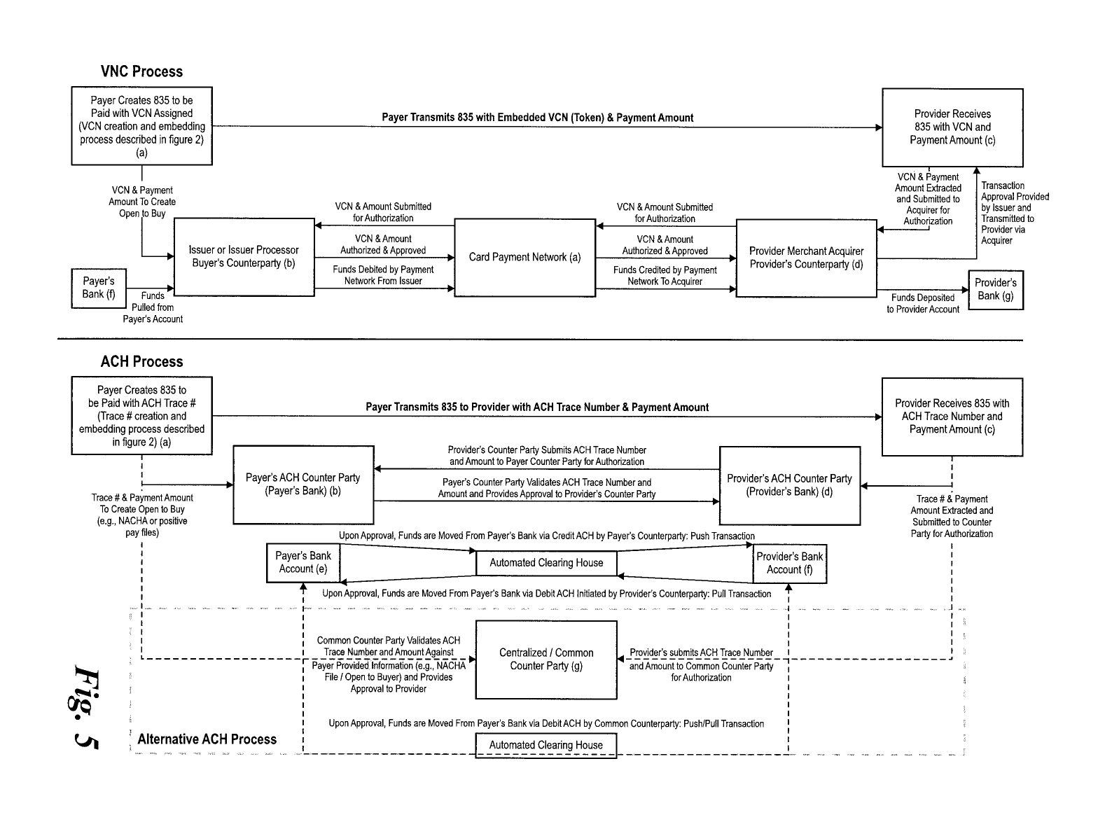

FIG. 4 describes how counter parties work with card payment networks and ACH transactions
a. Buyer creates remittances with embedded VCN token as described in FIG. 2, and transmits to Merchant via existing transmission mediums (e.g. US mail, file transfer protocol, email).
b. Buyer also sends notification to card issuer (and/or card processor) of the VCN issued, and the associated amount linked to the VCN via standard electronic file (e.g. file transfer protocol, EDI transmission). Notification establishes the Open to Buy as described in FIG. 2.
c. Merchant receives the remittance, and extracts the VCN, authorization amount (may include other identifying information).
d. VCN, amount (and other information) is submitted to merchant acquirer via point of sale terminal or API or other standard method for authorization.
e. Merchant Acquirer submits VCN and Amount to Issuer (and/or Issuer Processor) via the Card Payment Network.
   i. Card Payment Network transmits VCN and amount to Issuer (and/or Issuer Processor)—box (b) for authorization.
   ii. Issuer (and/or Issuer Processor—box (b)) validates VCN and amount against Open to Buy which was established from Buyer Notification.
   iii. Issuer (and/or Issuer Processor) confirms transaction with an approval code that is transmitted back to Card Payment Network
   iv. Card payment network transmits approval to merchant acquirer
   v. Merchant acquirer notifies merchant of approval via approval code.
f. Issuer moves funds from Buyer's funding account associated with authorization to Issuer's (and/or Issuer Processor's) card payment clearing account which they own
   i. Card payment network debits Issuer's clearing account
   ii. Card payment network credits Merchant Acquirers clearing account
g. Merchant Acquirer moves funds from clearing account to Merchant's bank account

ACH Process
a. Buyer creates remittances with embedded ACH Trace Number (token) as described in FIG. 2, and transmits to merchant via existing transmission mediums (e.g. US mail, file transfer protocol, email)
b. Buyer also sends notification to their ACH counterparty (which is typically their bank) which includes the ACH Trace # and associated amount linked to the Trace #. Notification can be provided via NACHA file or Positive Pay file (as examples).
c. Merchant receives the remittance, and extracts the Trace #, authorization amount (may include other identifying information).
d. Trace #, amount (and other information) is submitted to merchant counterparty (usually their bank) via point of sale terminal or API or other standard method for data transmission. Data transmission may be via NACHA file or Positive Pay file.
   i. Merchant counterparty submits Trace # and Amount to Buyer's counterparty for validation and approval
   ii. Approval is provided by Buyer's counterparty if Trace # and Amount match information provided by Buyer in NACHA file or Positive Pay file.
e. Upon approval, Buyer's counterparty initiates a credit ACH via the Automated Clearinghouse to move funds from the Buyer's Bank Account to the Merchant's Bank Account; or
f. Upon approval, Merchant's counterparty initiates a debit ACH via the Automated Clearinghouse to move funds from the Buyer's Bank account to the Merchant's Bank account
   iii. Utilizing this method, the Buyer's counterparty still acts as a gatekeeper of access to the Buyer's bank account. Only authorized transactions will be allowed to be debited from the bank account.
g. In an alternative instance, boxes (b) and (d) can be replaced with a common counterparty, e.g. a recognized and trusted counterparty that both Buyer and Merchant are comfortably using. Such entities include Chase Manhattan Bank, Bank of America, Discover Financial Network, etc.
   iv. In this case, the Common counterparty is in receipt of the NACHA or Positive Pay file provided by the Buyer and establishes the open to buy
   v. The merchant submits the Trace Number and Amount to the Common counterparty for validation against the open to buy
   vi. Upon confirmation that the transaction is valid, the Common counterparty initiates an ACH Debit from the Buyer's account and credits the Merchant Account via the Automated Clearinghouse.

### Utilizing Trusted Counterparties in the System

In the system, if a VCN is used as the token, then the Provider (acting as the merchant) leverages the services of a merchant acquirer to authorize and settle the payment for the 835. Merchant Acquirers exist today, and service merchants across the globe who accept credit and debit cards for payment. Examples of Merchant Acquirers include Vantiv, Chase Paymenech, First Data Merchant Services, and Elavon. The Provider receives the 835 remittance that includes the VCN (token) and payment amount along with other claim identifying information. In one example, the Provider or their PMS/HIS solution provider extracts the VCN from the TRN segment(s) along with the payment amount in the BPR segment(s) and submits them together to the Merchant Acquirer for authorization. The submission can take place via manually entry into a POS terminal, electronically via API connection with the Merchant Acquirer, or through any other means agreed upon between the parties. The Merchant Acquirer submits the VCN and amount for authorization through the card payment network, for authorization against the Issuer (and/or Issuer Processor's) open to buy which was initially provisioned at the start of The System process. When the VCN and amount is received by the Issuer, matched against the provisioned open to buy, the Issuer returns an approval code indicating that the transaction is valid and payment is authorized. The approval code is transmitted by the Issuer through the card payment network to the Merchant Acquirer. The Merchant Acquirer provides confirmation to the Provider (merchant) that the transaction is valid and has been authorized for payment settlement. Confirmation can take the form of an approval formatted as such: Approved 1234. Finally, and following current processes today, the card payment network debits the funds associated with the token which has been authorized from the Issuer's clearing account, and credits the same amount to the Merchant Acquirer's clearing account. The Merchant Acquirer transfers the same amount from their clearing account to the Provider's bank account based on already negotiated settlement terms in terms of timing of deposit.

The uniqueness of the VCN authorization model is that the Provider has a specific token which always links to the deposited payment in their bank account. Furthermore, they have been provided with an approval code which confirms that the exact amount of the payment requested has been approved. In this model, and unlike the current process, the Provider is in full control of the funding transaction, which includes: knowing the amount to be paid, knowing the timing of when funds will be deposited, knowing exactly which remittance the fund deposit links to (via common token).

In the system, if a ACH trace number is used as the token, then the Provider (acting as the merchant) leverages the services of a merchant counterparty (usually their bank) to authorize and settle the payment for the 835. Merchant counter parties exist today, and service merchants across the globe who initiate and receive ACH payment transactions. Examples of Merchant counter parties include Chase, Bank of America, Citibank. The Provider receives the 835 remittance that includes the ACH Trace Number (token) and payment amount along with other claim identifying information. In one example, the Provider or their PMS/HIS solution provider extracts the ACH Trace Number from the TRN segment(s) along with the payment amount in the BPR segment(s) and submits them together to their Merchant Counterparty. The submission to the Merchant counterparty can (amongst other methods) happen via electronic file transfer in the NACHA or positive pay file formats, and transmits, electronically via API connection or any other predefined and agreed upon electronic file transfer protocol. The merchant counterparty submits the trace number and amount for authorization to the healthcare payer's (the entity that created the 835, also known as the buyer) counterparty to validate against the originally provisioned open to buy at the start of The System process. When the Trace Number and amount is received by the Payer's counterparty, matched against the provisioned open to buy, the Payer counterparty returns an approval code indicating that the transaction is valid and payment is authorized. The approval code is transmitted directly to the Provider's counterparty. The Provider's counter provides confirmation to the Provider (merchant) that the transaction is valid and has been authorized for payment settlement. Confirmation can take the form of an approval formatted as such: Approved 1234. Finally, and following current ACH processes today, the counter parties settle payment by moving the funds from the Payer's bank account to the Provider's bank account. In the case of a debit ACH, the Provider's counterparty initiates a debit ACH transaction through the Automated clearinghouse. In the case of a credit ACH, the Payer's counterparty initiates the transfer from the Payer's bank account to the Provider's account through the automated clearinghouse. The Automated Clearinghouse knows which banks are participating and which bank is the source of funds based on the first few digits (5) of the Trace Number which is a bank identifier within their Trace Number schema. The number of digits within the Trace Number that identifies the originating bank is an example, and is established by the ACH network. Whatever the requirement is, it can be deployed in this system.

The uniqueness of the ACH trace number authorization model is that the healthcare Provider receives an 835-remittance advice from a payer which has an embedded token generated by the payer which links the 835 to the deposited payment in the provider's bank account. Furthermore, they have been provided with an approval code which confirms that the exact amount of the payment requested has been approved. In this model, and unlike the current process, the Provider is in full control of the funding transaction, which includes: knowing the amount to be paid, knowing the timing of when funds will be deposited, knowing exactly which remittance the fund deposit links to (via common token).

FIG. 5 shows how counter parties are used in the system to authorize and settle payment
a. Payer creates remittances with embedded VCN token as described in FIG. 2, and transmits to Provider via existing transmission mediums (e.g. US mail, file transfer protocol, email). Claims, i.e. 835 forms, are received from healthcare providers by payer's computer system by way of an electronic data exchange network. Once the claim is adjudicated, an 835 remittance is generated by payer's computer system in a manner known in the art. In accordance with one aspect of the invention a trace or token is embedded in the 835 before it is sent to the healthcare provider and payer's counterparty for payment. The trace or token links ACH and VCN payments to specific 835 remittances. The token may be generated by Payer's computer system or a third party as discussed above.
b. Payer also sends notification to card issuer (and/or card processor) of the VCN issued, and the associated amount linked to the VCN via standard electronic file (e.g. file transfer protocol, EDI transmission). Notification establishes the Open to Buy as described in FIG. 2. Notification is transmitted via communication network, internet, or other electronic protocol.
c. Provider receives the remittance, and extracts the VCN, authorization amount (may include other identifying information). The provider's PMS or HIS which receives the remittance is typically accessed via a computer with memory, and the 835 data is loaded into the PMS or HIS database.
d. VCN, amount (and other information) is submitted to merchant acquirer via a physical point of sale terminal or API or other standard method for authorization in a known manner.
e. Merchant Acquirer submits VCN and Amount to Issuer (and/or Issuer Processor) via the Card Payment Network. The Merchant Acquirer's transmission may be by secure telecommunications connection, virtual private network, internet connection or other telecommunication tool commonly used in the industry. Hardware used to support such connections include servers, routers, hubs and other computer systems.
   i. Card Payment Network transmits VCN and amount to Issuer (and/or Issuer Processor)—box (b) for authorization.
   ii. Issuer (and/or Issuer Processor—box (b)) validates VCN and amount against Open to Buy which was established from Payer Notification. Issuer systems typically include mainframe computers with memory and a database. Issuer systems are connected to the card payment network via telecommunications equipment and protocols typically utilized in the industry (hubs, routers, switches, Ethernet/Coaxial/Copper cables)
   iii. Issuer (and/or Issuer Processor) confirms transaction with an approval code that is transmitted back to Card Payment Network
   iv. Card payment network transmits approval to merchant acquirer
   v. Merchant acquirer notifies Provider of approval via approval code.
f. Issuer moves funds from Payer's funding account associated with authorization to Issuer's (and/or Issuer Processor's) card payment clearing account which they own
   i. Card payment network debits Issuer's clearing account
   ii. Card payment network credits Merchant Acquirers clearing account
g. Merchant Acquirer moves funds from clearing account to Provider's bank account

ACH Process
a. Payer creates remittances with embedded ACH Trace Number (token) as described in FIG. 2, and transmits to Provider via existing transmission mediums (e.g. US mail, file transfer protocol, email). Typically, the remittances are transmitted electronically by way of payer's computer system and communication network in a known manner over an EDI network.
b. Payer also sends notification electronically to their ACH counterparty (which is typically their bank) which includes the ACH Trace # and associated amount linked to the Trace #. Notification can be provided via NACHA file or Positive Pay file (as examples).
c. Healthcare Provider receives the 835 remittance within their PMS and/or HIS over an EDI network for example, and extracts the Trace #, authorization amount (may include other identifying information) in a known manner.
d. Trace #, amount (and other information) is submitted to Provider counterparty (usually their bank) via point of sale terminal or API or other standard method for data transmission. Data transmission may be via NACHA file or Positive Pay file.
   i. Provider counterparty submits Trace # and Amount to Payer's counterparty for validation and approval. Counterparty systems include both computer systems and communications systems.
   ii. Approval is provided by Payer's counterparty if Trace # and Amount match information provided by Payer in NACHA file or Positive Pay file.
e. Upon approval, Payer's counterparty initiates a credit ACH via the Automated Clearinghouse to move funds from the Payer's Bank Account to the Provider's Bank Account; or
f. Upon approval, Provider's counterparty initiates a debit ACH via the Automated Clearinghouse to move funds from the Payer's Bank account to the Provider's Bank account
g. Utilizing this method, the Payer's counterparty still acts as a gatekeeper of access to the Payer's bank account. Only authorized transactions will be allowed to be debited from the bank account.
   iii. In an alternative instance, boxes (b) and (d) can be replaced with a common counterparty, e.g. a recognized and trusted counterparty that both Payer and Provider are comfortably using. Such entities include Chase Manhattan Bank, Bank of America, Discover Financial Network, etc.
   iv. In this case, the Common counterparty is in receipt of the NACHA or Positive Pay file provided by the Payer and establishes the open to buy
   v. The Provider submits the Trace Number and Amount to the Common counterparty for validation against the open to buy
   vi. Upon confirmation that the transaction is valid, the Common counterparty initiates an ACH Debit from the Payer's account and credits the Provider Account via the Automated Clearinghouse.

### A Mechanism to Charge for the System

The Card Payment Networks and/or Payment Services providers not only provision the standards that govern tokenized transactions and the communication networks through which transactions are authorized and settled; they also have an embedded platform to administer any pricing structure established by the system participants.

For example, the participants may establish that the value delivered by this process is worth 50 basis points of the amount settled on the token. The participants may also agree that the 50 basis points will be split equally amongst: the issuer, the merchant acquirer, the card payment network, the PMS platform provider and the Issuer Processor. To fund the 50 basis points, both the Payer and the Provider might agree to fund 10 bps and 40 bps respectively. For a $250 transaction, the settlement may resemble the following:
$250.00 is authorized
The Card Network debits the Issuer account for $249.75
The Issuer debits the Payer's account for $250.25
The Issuer transfers $0.25 to the Issuer Processor
The Card Network transfers $249.50 to the Merchant Acquirer
The Merchant Acquirer transfers $249.00 to the Provider's bank account
The Merchant Acquirer transfers $0.25 to the PMS platform account The same framework would apply to a Payment Services Provider over the ACH network

### Benefits of the System

There are many benefits of the system, including:
The elimination of paper and the associated costs and environmental impacts
The reduction of work-effort associated with manual data entry and transaction reconciliation
The guarantee of funding & settlement to the Provider
The guaranteed linkage of funds to the remittance to which it belongs
Faster receipt and application of cash
Complete and electronically efficient reconciliation of the remittance transaction to the financial settlement

While the cost savings associated with the elimination of paper are well documented, and the efficiencies promised by electronic transaction processing are formidable, status quo processing of claims payments absent the system neither eliminate the paper, nor deploy the electronic process efficiently. Configuring a process or work-flow that allows detailed remittance data to post electronically, payments to be submitted for authorization and approval in real time, while ensuring the Provider's PMS is in full control of the funding transaction, and informed of funding settlement without human intervention delivers the promised operational and administrative savings of healthcare claims processing automation.

Obviously, many modifications and variations of the present system are possible in light of the above teachings. Thus, it is to be understood that, within the scope of the appended claims, the invention may be practiced otherwise than as specifically described above.

What is claimed and desired to be secured by a Letters Patent of the United States is:

I claim:

1. A system for reconciling remittances for health care services with an originating claim, the system comprising:
a healthcare provider system for generating healthcare electronic claim forms for healthcare services and items provided to patients, said electronic claim form configured to be transmitted to a payer over an electronic network to be received by a payer;
a healthcare payer system for receiving said electronic claim forms from said payer, said healthcare payer system configured to adjudicate said claim forms and issue remittance advice and payment to said providers, wherein said healthcare payer system is configured to generate tokens and embed said tokens into said remittance advice and send said remittance advice to said healthcare provider and embed said tokens into electronic payment instructions to a trusted party, wherein said trusted party is configured to transfer funds to said healthcare provider's account upon request of said healthcare provider matching the token provided by said healthcare provider.

2. The system as recited in claim 1, wherein said electronic payment advice includes a virtual card number (VCN) funds transfer.

3. The system as recited in claim 1, wherein said electronic payment advice includes a payment instruction for an automated clearing house (ACH) funds transfer.

4. The system as recited in claim 1, wherein said token is generated by a third party.

5. The system as recited in claim 1, wherein said remittance advice is generated by a third party.

6. The system as recited in claim 1, wherein said third party generates said token and embeds it into said remittance advice.

7. The system as recited in claim 1, wherein the trusted party is the payer's bank.
